(19) United States
(12) Patent Application Publication
(10) Pub. No.: US 2004/0078412 A1
(43) Pub. Date: Apr. 22, 2004

(54) Parallel processing method of an eigenvalue problem for a shared-memory type scalar parallel computer

(75) Inventor: Makoto Nakanishi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/677,693

(22) Filed: Oct. 2, 2003

Related U.S. Application Data
(63) Continuation-in-part of application No. 10/289,648, filed on Nov. 7, 2002.

(30) Foreign Application Priority Data
Mar. 28, 2003 (JP) 2003-92611
Mar. 29, 2002 (JP) 2002-97835

(51) Int. Cl. G06F 7/32

(52) U.S. Cl. 708/520

(57) ABSTRACT

A method for solving an eigenvalue problem is divided into three steps of tri-diagonalizing a matrix; calculating an eigenvalue and an eigenvector based on the tri-diagonal matrix; and converting the eigenvector calculated based on the tri-diagonal matrix and calculating the eigenvector of the original matrix. In particular, since the cost of performing the tri-diagonalization step and original matrix eigenvector calculation step are large, these steps can be processed in parallel and the eigenvalue problem can be solved at high speed.

### CROSS-REFERENCE

This application is a continuation-in-part application of U.S. patent application Ser. No. 10/289,648, filed on Nov. 7, 2002, now abandoned.

### BACKGROUND OF THE INVENTION

1. Field of the Invention

The present invention relates to matrix calculation in a shared-memory type scalar parallel computer.

2. Description of the Related Art

First, in order to solve the eigenvalue problem of a real symmetric matrix (matrix composed of real numbers, which does not changed even if the matrix elements are transposed) and an Hermitian matrix (matrix composed of complex numbers, which does not changed even if conjugated and transposed) (calculating λ, in which det|A−λI|=0, and the eigenvector thereof if a matrix, a constant and a unit matrix are assumed to be A, λ and I, respectively), tri-diagonalization (conversion into a matrix with a diagonal factor and adjacent factors on both sides only) has been applied. Then, the eigenvalue problem of this tri-diagonal matrix is solved using a multi-section method. The eigenvalue is calculated and the eigenvector is calculated using an inverse repetition method. Then, Householder conversion is applied to the eigenvector, and the eigenvector of the original eigenvalue problem is calculated.

In a vector parallel computer, an eigenvalue problem is calculated assuming that memory access is fast. However, in the case of a shared-memory type scalar parallel computer, the larger the matrix to be calculated, the greater the number of accesses to shared memory. Therefore, the performance of the computer is greatly decreased by accessing shared memory at low speed, which is a problem. Therefore, a matrix must be calculated effectively using a cache memory with fast access installed in each processor of a shared-memory type scalar parallel computer. Specifically, if a matrix is calculated for each row or column, the number of accesses to shared memory increases. Therefore, a matrix must be divided into blocks and shared memory must be accessed after each processor processes data stored in a cache memory as much as possible. In this way, the number of accesses to shared memory can be reduced. In this case, it becomes necessary for each processor to have a localized algorithm.

In other words, since a shared-memory type parallel computer does not have fast memory access capability like a vector parallel computer, an algorithm must be designed to increase processing amount against accesses to shared memory.

### SUMMARY OF THE INVENTION

It is an object of the present invention to provide a parallel processing method for calculating an eigenvalue problem at high speed in a shared-memory type scalar parallel computer.

The parallel processing method of the present invention is a program enabling a computer to solve an eigenvalue problem on a shared-memory type scalar parallel computer. The method comprises dividing a real symmetric matrix or Hermitian matrix blocks, copying each divided block in the work area of memory and tri-diagonalizing the matrix using each product between the divided blocks; calculating an eigenvalue and an eigenvector based on the tri-diagonalized matrix; and converting the eigenvector by Householder conversion in order to transform the calculation into the parallel calculation of matrix calculations with a prescribed width of a block and calculating the eigenvector of the original matrix.

According to the present invention, an eigenvalue problem can be solved with the calculation localized as much as possible in each processor of a shared-memory type scalar parallel computer. Therefore, delay due to frequent accesses to shared memory can be minimized, and the effect of parallel calculation can be maximized.

### BRIEF DESCRIPTION OF THE DRAWINGS

The present invention will be more apparent from the following detailed description in conjunction with the accompanying drawings, in which:

FIG. 1 shows the hardware configuration of a shared-memory type scalar parallel computer assumed in the preferred embodiment of the present invention;

FIG. 2 shows the algorithm of the preferred embodiment of the present invention (No. 1);

FIG. 3 shows the algorithm of the preferred embodiment of the present invention (No. 2);

FIGS. 4A through 4F show the algorithm of the preferred embodiment of the present invention (No. 3);

FIG. 5A through 5F show the algorithm of the preferred embodiment of the present invention (No. 4);

FIG. 6 shows the algorithm of the preferred embodiment of the present invention (No. 5);

FIG. 7 shows the algorithm of the preferred embodiment of the present invention (No. 6);

FIG. 8 shows the algorithm of the preferred embodiment of the present invention (No. 7);

FIG. 9 shows the algorithm of the preferred embodiment of the present invention (No. 8);

FIG. 10 shows the algorithm of the preferred embodiment of the present invention (No. 9);

FIG. 11 shows the algorithm of the preferred embodiment of the present invention (No. 10);

FIG. 12 shows the pseudo-code of a routine according to the preferred embodiment of the present invention (No. 1);

FIG. 13 shows the pseudo-code of a routine according to the preferred embodiment of the present invention (No. 2);

FIG. 14 shows the pseudo-code of a routine according to the preferred embodiment of the present invention (No. 3);

FIG. 15 shows the pseudo-code of a routine according to the preferred embodiment of the present invention (No. 4);

FIG. 16 shows the pseudo-code of a routine according to the preferred embodiment of the present invention (No. 5);

FIG. 17 shows the pseudo-code of a routine according to the preferred embodiment of the present invention (No. 6); and

FIG. 18 shows the pseudo-code of a routine according to the preferred embodiment of the present invention (No. 7).

FIGS. 19 through 29 are flowcharts showing a pseudo-code process.

### DESCRIPTION OF THE PREFERRED EMBODIMENTS

In the preferred embodiment of the present invention, a blocked algorithm is adopted to solve the tri-diagonalization of the eigenvalue problem. The algorithm for calculating a divided block is recursively applied and the calculation density in the update is improved. Consecutive accesses to a matrix vector product can also be made possible utilizing symmetry in order to prevent a plurality of discontinuous pages of memory from being accessed. If data are read across a plurality of pages of cache memory, sometimes the data cannot be read at one time and the cache memory must be accessed twice. In this case, the performance of the computer degrades. Therefore, data is prevented from spanning a plurality of pages of cache memory.

When applying Householder conversion to the eigenvector of a tri-diagonalized matrix and calculating the eigenvector of the original matrix, calculation density is improved by bundling every 80 iterations of the Householder conversion and calculating three matrix elements.

In the preferred embodiment of the present invention, conventional methods are used to calculate an eigenvalue based on a tri-diagonalized matrix and to calculate the eigenvector of the tri-diagonalized matrix,

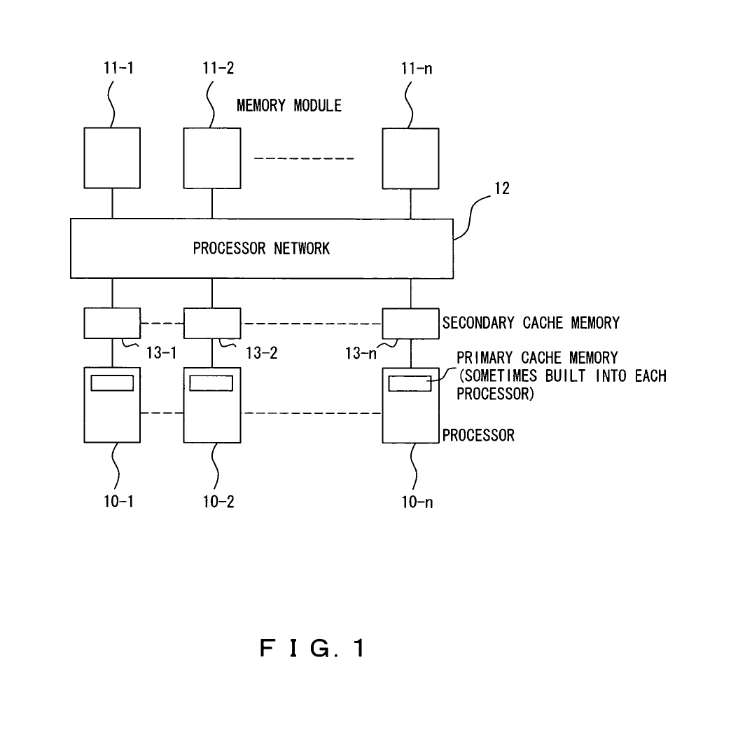

FIG. 1 shows the hardware configuration of a shared-memory type scalar parallel computer assumed in the preferred embodiment of the present invention.

Each of processors 10-1 through 10-n has primary cache memory, and this primary cache memory is sometimes built into each processor. Each of the processors 10-1 through 10-n is also provided with each of secondary cache memories 13-1 through 13-n, and each of the secondary cache memories 13-1 through 13-n is connected to an interconnection network 12. The interconnection network 12 is also provided with memory modules 11-1 through 11-n, which are shared memories. Each of the processors 10-1 through 10-n reads necessary data from one of the memory modules, stores the data in one of the secondary cache memories 13-1 through 13-n or one of the primary cache memories through the interconnection network 12, and performs calculation.

In this case, the speed of reading data from one of the memory module 11-1 through 11-n into one of the secondary cache memories 13-1 through 13-n or one of the primary cache memories and the speed of writing calculated data into one of the memory modules 11-1 through 11-n from one of the primary cache memories is very low compared with the calculation speed of each of the processors 10-1 through 10-n. Therefore, the frequent occurrence of such reading or writing degrades the performance of the entire computer.

Therefore, in order to keep the performance of the entire computer high, an algorithm that reduces the number of accesses to each of the memory modules 11-1 through 11-n as much as possible and performs as much calculation as possible in a local system comprised of the secondary cache memories 13-1 through 13-n, primary cache memories and processors 10-1 through 10-n is needed.

### Method for Calculating an Eigenvalue and an Eigenvector

1. Tri-Diagonalization Part

1) Tri-Diagonalization

a) Mathematical Algorithm for Divided Tri-Diagonalization

A matrix is tri-diagonalized for each block width. Specifically, a matrix is divided into blocks and each divided block is tri-diagonalized using the following algorithm.

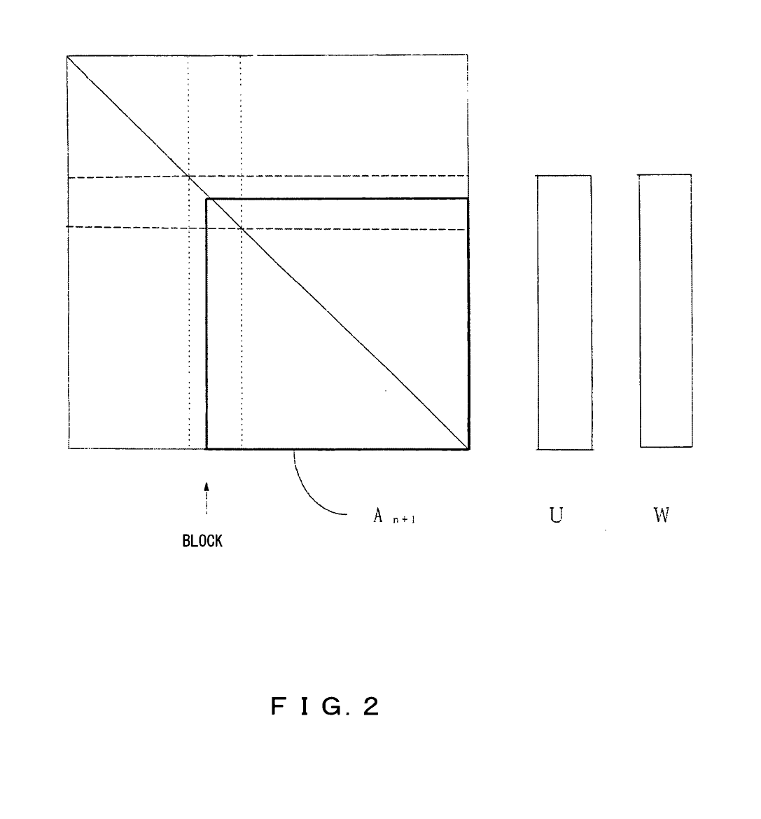

FIGS. 2 through 11 show the algorithm of the preferred embodiment of the present invention.

FIG. 2 shows the process of the m-th divided block. In this case, a block is the rectangle with a column and a row, which are indicated by dotted lines, as each side shown in FIG. 2.

For the process for a last block, the algorithm is applied to 2×2 matrix with block width 2 located in the left hand corner and then the entire process terminates.

do i=1,blks

step1: Create a Householder vector u based on the (n+1)th row vector of Aₙ.

step2: Calculate vᵢ=Aₙ₊ᵢu and wᵢ=vᵢ−u(u^{t}v)/2.

step3: Update as Uᵢ=(Uᵢ₋₁,uᵢ) and Wᵢ=(Wᵢ₋₁,wi) (In this case, (Uᵢ₋₁,uᵢ) expands the matrix by one column by creating matrix Uᵢ based on matrix Uᵢ₋₁ by adding one column).

step4: if (i<blks) then

Update the (n+i+1)th column of Aₙ.

Aₙ(*,n+i+1)=Aₙ(*,n+i+1)−UᵢWᵢ(n+i+1)^{t}−WᵢUᵢ(n+i+1,*)^{t}

endif

enddo

step5: A_{n+blks}=Aₙ−U_{blks}W_{blks}^{t}−W_{blks}U_{blks}^{t}

Tri-diagonalization by divided Householder conversion

Explanation of Householder conversion

v=(v₁,v₂, . . . , vₙ)

|v|²=v*v=h²

If Uᵥ=(h,0, . . . , 0)^{t}, there is the relationship of Uᵥ=v−(v₁−h,v2, . . . , vₙ).

U=(1−uu^{t}/|u|²)=(1−αuu^{t}), where u=(v₁−h,v₂, . . . , vₙ).

In the calculation below, α is neglected.

$$\begin{matrix}{A}_{n + 1} = {U}^{t} {A}_{n} U = ( 1 - u {u}^{t} ) A ( 1 - u {u}^{t} ) \\ = {A}_{n} - u {u}^{t} {A}_{n} - {A}_{n} u {u}^{t} + u {u}^{t} {A}_{n} u {u}^{t} \\ = {A}_{n} - u {w}^{t} - u {u}^{t} {u}^{t} v / 2 - w {u}^{t} {u}^{t} v / 2 + u {u}^{t} {u}^{t} v \\ = {A}_{n} - u {w}^{t} - w {u}^{t}\end{matrix} \qquad (* )$$

where w=v−u(u^{t}v)/2 and v=Aₙu

This is repeated,

Aₙ₊ₖ=Aₙ−UₖWₖ^{t}−WₖUₖ^{t} (**)

As the calculation in the k-th step, Vₙ can be calculated according to equations (*) and (**) as follows.

vₖ=Aₙuₖ−Uₖ₋₁Wₖ₋₁^{t}uₖ−Wₖ₋₁Uₖ₋₁^{t}uₖ (***)

wₖ=vₖ−uₖuₖ^{t}vₖ/2

Uₖ=(Uₖ₋₁,uₖ), Wₖ=(Wₖ₋₁,wₖ)

Aₙ₊ₖ=Aₙ−UₖWₖ^{t}−WₖUₖ^{t}

b) Storage of Information Constituting Householder Conversion

The calculation of an eigenvector requires the Householder conversion, which has been used in the tri-diagonalization. For this reason, Uₙ and α are stored in the position of a vector constituting the Householder conversion. α is stored in the position of a corresponding diagonal element.

c) Method for Efficiently Calculating Uᵢ

In order to tri-diagonalize each block, the following vectors used for Householder conversion must be updated. In order to localize these calculations as much as possible, a submatrix of the given block width must be copied into a work area, is tri-diagonalized and is stored in the original area. Instead of updating a subsequent column vector for each calculation, calculation is performed in the form of a matrix product with improved calculation density. Therefore, the tri-diagonalization of each block is performed by a recursive program.

recursive subroutine trid (width, block area pointer)

if(width<10) then

c Tri-Diagonalize the Block With the Width.

Create vᵢ and wᵢ based on vector u needed for Householder conversion and a matrix vector product.

Combine uᵢ and wᵢ with U and W, respectively.

else

c Divide a Block Width Into Halves.

C Tri-Diagonalize the Former Half Block.

call trid (width of the former half, area of the former half)

c Divide a Block and Update the Latter Half Divided by a Division Line.

Update B=B−UW^{t}−WU^{t}.

c Then, Tri-Diagonalize the Latter Half.

call trid (width of the latter half, area of the latter half)

return

end

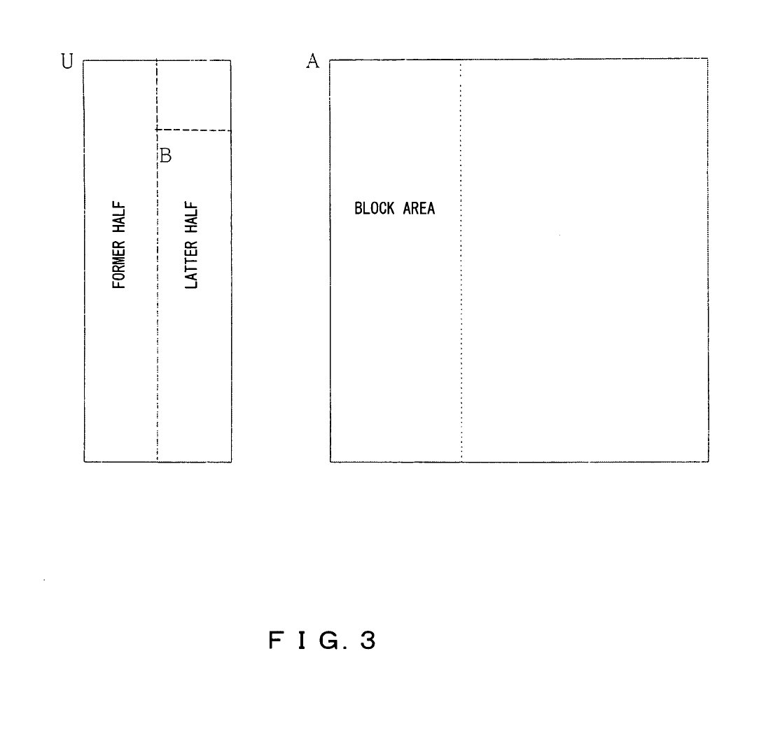

As shown in FIG. 3, a block is copied into a work area U and the block is tri-diagonalized by a recursive program. Since the program is recursive, the former half shown in FIG. 3 is tri-diagonalized when the recursive program is called for the update process of the former half. The latter half is updated by the former half and then is tri-diagonalized.

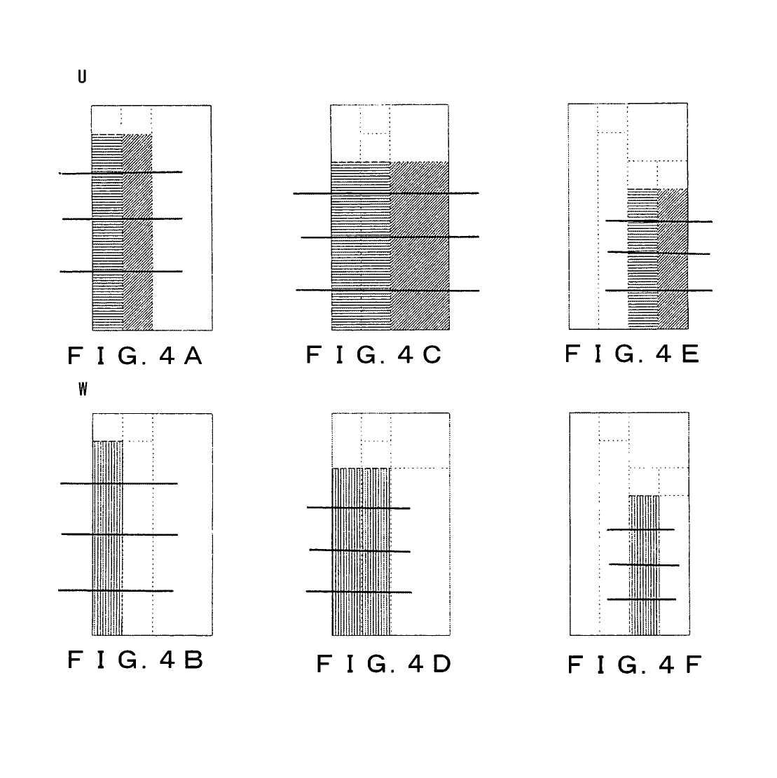

As shown in FIGS. 4A through 4F, when the recursive program is called to a depth of 2, the shaded portion shown in FIG. A is updated to B in the first former half process and then the shaded portion shown in FIG. 4C is updated and lastly the shaded portion shown in FIG. 4F is updated. In parallel calculation at the time of update, the block matrix of the updated portion is evenly divided vertically into columns (divided in a row vector direction), and the update of each portion is performed in parallel by a plurality of processors.

The calculation of FIG. 4B is performed after the calculation of FIG. 4A, the calculation of FIG. 4D is performed after the calculation of FIG. C and the calculation of FIG. 4F is performed after the calculation of FIG. 4E.

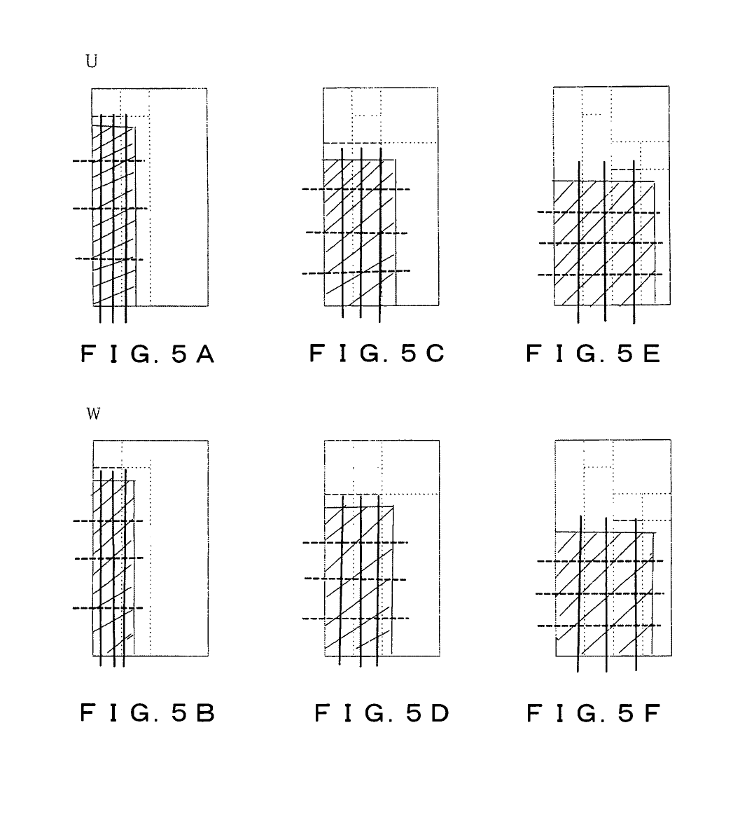

As shown in FIG. 5, when the shaded portion of U is updated, the horizontal line portion of u and the vertical line portion of W are referenced. In this way, calculation density can be improved. Specifically, Vₙ can be calculated according to the following equation (**).

Aₙ₊ₖ=Aₙ−UₖWₖ^{t}−WₖUₖ^{t} (**)

In this case, the reference pattern of U and W is determined according to the following equation (***).

vₖ=Aₙuₖ−Uₖ₋₁Wₖ₋₁^{t}uₖ−Wₖ₋₁^{t}uₖ (***)

vₖ is calculated for the tri-diagonalization of the updated portion after the update of U shown in FIGS. 4A and 4B, 4C and 4D, and 4E and 4F, U and W are referenced and vₖ is calculated using a matrix vector product. Since this is just a reference, and the update and reference of U have a common part, U and W can be efficiently referenced. Instead of updating Aₙ each time, only a necessary portion is updated using U and W. Using equation (**), the calculation speed of the entire update is improved, and performance is improved accordingly. Although equation (***) is extra calculation, it does not affect the performance of the entire calculation as long as the block width is kept narrow.

For example, if four computers perform the parallel process, in the calculation of Wₖ₋₁^{t}uₖ and Uₖ₋₁^{t}uₖ of equation (***), the shaded portion is divided in the direction of a vertical line(divided by horizontal lines), and parallel calculation is performed. As for the product of the results, the shaded portion is divided in the direction of a broken line, and parallel calculation is performed.

Parallel Calculation of vᵢ=Aₙuᵢ

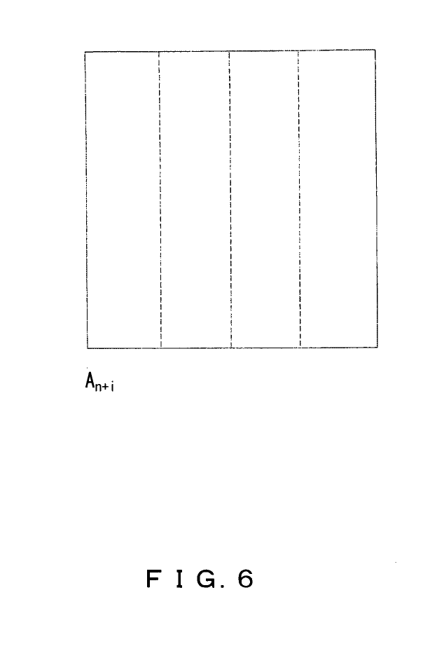

As shown in FIG. 6, each processor divides the shaded portion in the second dimensional direction utilizing the symmetry of Aₙ, that is, Aₙ=Aₙ^{t} and each processor calculates vᵢ by Aₙ(*, ns:ne)^{t}uᵢ.

2)Parallel Calculation in Shared-Memory Type Scalar Parallel Computer

a) A storage area for U and W is allocated in shared memory. A block area to be tri-diagonalized is copied into a work area allocated separately and tri-diagonalization is applied to the area.

The parallel calculation of the recursive program described above is as follows.

(1) Necessary vectors are calculated according to the following equation of step 4 in order to calculate uᵢ needed to perform Householder conversion

Aₙ(*,n+i+1)=Aₙ(*,n+i+1)−UᵢWᵢ(n+i+1)^{t}−WᵢUᵢ(n+i+1,*)^{t}

(2) vᵢ is Calculated in Step 2

This is calculated by making uᵢ act on the following equation (**).

Aₙ₊ₖ=Aₙ−UₖWₖ^{t}−WₖUₖ^{t}

In this calculation, the product of Aₙ and uᵢ, and the product of UₖWₖ^{t}−WₖUₖ^{t} and uᵢ are processed in parallel.

The block is copied in a work area and care must be paid so as not to update the necessary portion of Aₙ. The block is divided into matrices extended in a column vector direction (divided into columns) utilizing the symmetry of Aₙ, and parallel calculation is performed.

(3) In the Recursive Program, a Block Area is Updated Utilizing the Following Equation.

Aₙ₊ₖ=Aₙ−UₖWₖ^{t}−WₖUₖ^{t}

In this way, the amount of calculation of (1) is reduced.

3)Update in Step 5

Utilizing symmetry during update, only the lower half of a diagonal element is calculated. In parallel calculation, if the number of CPUs is #CPU, in order to balance load, a sub-array, in which a partial matrix to be updated is stored, is evenly divided into 2×#CPU in the second dimensional direction and the CPUs are numbered from 1 to 2×#CPU. The i-th processor of each of 1 through #CPU updates in parallel the i-th and (2×#CPU+1−i)th divided sub-arrays.

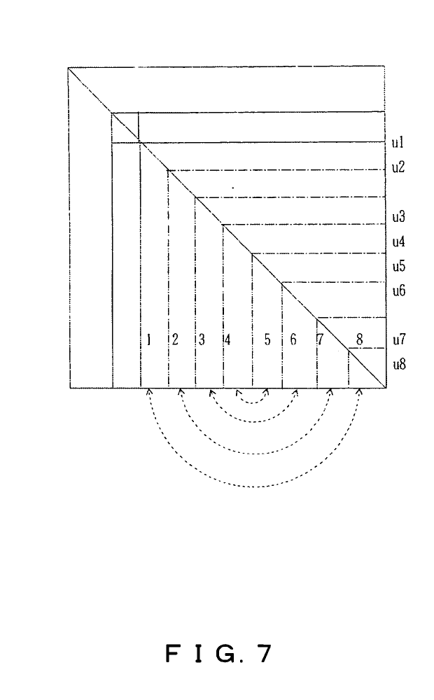

Then, calculated result is copied into the upper half. Similarly, this is also divided and the load is balanced. In this case, portions other than the diagonal block are divided into fairly small blocks so that data are not read across a plurality of pages of cache memory and are copied. The lower triangular matrix is updated by Aₙ₊ₖ=Aₙ−UₖWₖ^{t}−WₖUₖ^{t}. In this case, the lower triangular matrix is divided into #CPU×2 of column blocks, two outermost blocks, one at each end are sequentially paired. Each CPU updates such a pair. FIG. 7 shows a case where four CPUs are provided.

After the lower triangular part is updated, the same pairs consisting of blocks 1 through 8 are transposed into an upper triangle portion and are copied into u1 through u8.

In this case, the block is divided into small internal square blocks and is transposed using the cache. Then, the blocks are processed in parallel as during an update.

Explanation on the Improvement of the Performance by Transposition in the Cache

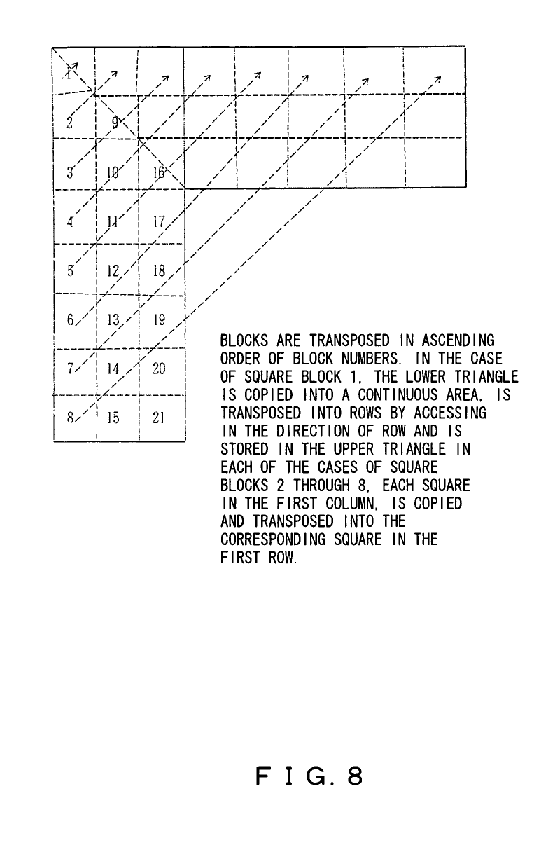

As shown in FIG. 8, square blocks are transposed and converted in ascending order of block numbers. The lower triangle of square area 1 is copied into the continuous area of memory, is transposed into rows by accessing in the direction of row and stored in the upper triangle of square area 1. Each square in the first column, namely squares 2 through 8, is copied and transposed into the corresponding square in the first row.

2. Calculation of Eigenvectors

a) Basic algorithm

Vector uₙ is stored, then (1−2*uu^{t}/(u^{t}u)) is created and (1−2*uu^{t}/(u^{t}u)) is multiplied by the vector.

If tri-diagonalization is performed, the original eigenvalue problem can be transformed as follows.

Qₙ₋₂ . . . ·Q₂Q₁AQ₁^{t}Q₂^{t} . . . ·Qₙ₋₂^{t}Qₙ₋₂ . . . ·Q₂Q₁x=λQₙ₋₂ . . . ·Q₂Q₁x

Conversion is performed by calculating x=Q₁^{t}Q₂^{t} . . . ·Qₙ₋₃^{t}Qₙ₋₂^{t}y based on the eigenvector y calculated by solving the tri-diagonalized eigenvalue problem.

b) Block algorithm of the preferred embodiment of the present invention and parallel conversion calculation of eigenvectors

When calculating many or all eigenvectors, the eigenvectors of tri-diagonal matrix are evenly assigned to each CPU, and each CPU performs the conversion described above in parallel. In this case, approximately 80 conversion matrices are collectively converted.

Each conversion matrix Qᵢ^{t} can be expressed as 1+αᵢuᵢuᵢ^{t}. The product of these matrices can be expressed as follows.

$$1 + {\sum }_{i = n}^{n + k - 1} {u}_{i} ( {\sum }_{j = 1}^{n + k - 1} {b}_{i j} {u}_{j}^{t} )$$

where

b_{i,j}: The collection of scalar coefficients other than uᵢuⱼ at the leftmost and rightmost ends

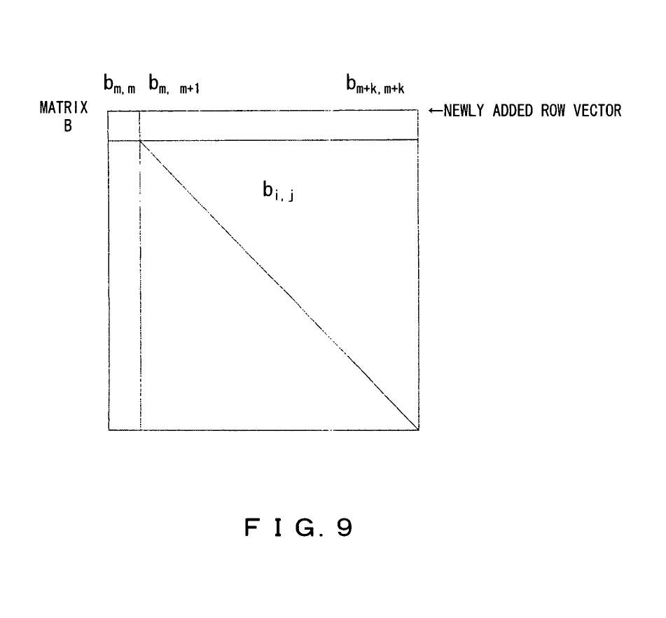

b_{i,j} becomes an upper triangular matrix. Each conversion matrix Qᵢ^{t} can be transformed into 1+UBU^{t}. Using this transformation, calculation density can be improved, and calculation speed can be improved accordingly. FIG. 9 shows a typical matrix B.

Although the method described above has three steps, matrices to be processed become are U and B according to such memory access. Since B can be made fairly small, high efficiency can be obtained. After the (m−1)th b_{i,j} is calculated, all b_{i,j} is multiplied by (1+αₘUₘUₘ^{t}), and the following expression can be obtained.

$$1 + {\sum }_{i} {u}_{i} ( {\sum }_{j} {b}_{i j} {u}_{j}^{t} ) + {α}_{m} {U}_{m} {U}_{m}^{t} + {U}_{m} {\sum }_{i} {α}_{m} {u}_{m}^{t} {u}_{i} ( {\sum }_{j} {b}_{i j} {u}_{j}^{t} )$$

If i and j are swapped in the sum of the last term, the expression can be modified as follows.

Uₘ(Σ(Σαₘuₘ^{t}uᵢbᵢⱼ)uⱼ^{t})

The item located in the innermost parenthesis can be regarded as b_{m,j} (j=m+1, . . . , n+k) . In this case, b_{m,m} is αₘ.

A square work array W2 is prepared, and first, α₁UᵢUⱼ^{t} is stored in the upper triangle of w2(i,j). α_{I} is stored in the diagonal element.

The method described above can be calculated by sequentially adding one row on the top of each of the matrices upwards beginning with the 2×2 upper triangular matrix in the lower right corner.

If each of the elements is calculated beginning with the rightmost row element, calculation can be performed in the same area since B is an upper triangular matrix and the updated portion is not referenced. In this way, a coefficient matrix located in the middle of three matrix products can be calculated using only very small areas.

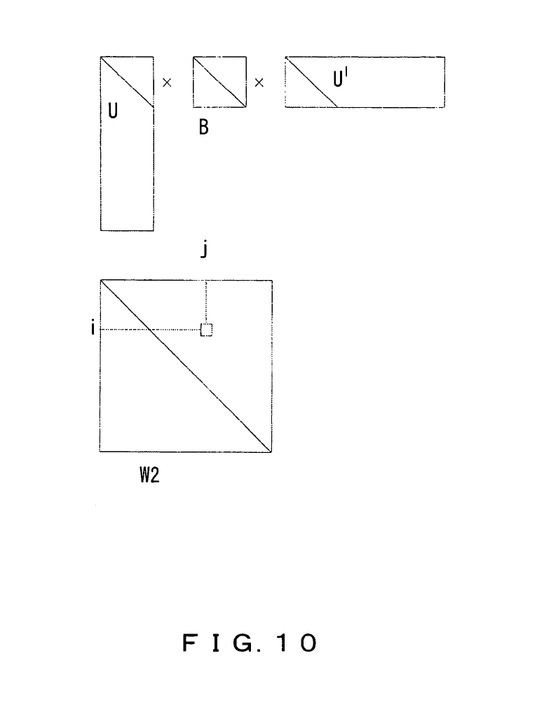

FIG. 10 shows a typical method for calculating the eigenvalue described above.

Block width is assumed to be nbs.

First, inner product αⱼuᵢ·uⱼ is calculated and is stored in the upper half of B.

αᵢ is stored in the diagonal element.

Then, calculation is performed as follows.

do i1=nbs−2, 1, −1

do i2=nbs, i1+1, −1

sum=w2 (i1, i2)

do i3=i2−1, i1+1, −1

sum=sum+w2 (i1, i3)*w2 (i3, i2)

enddo

w2 (i1, i2)=sum

enddo

enddo

do i2=nbs, 1, −1

do i1=i2−1, 1, −1

w2 (i1, i2)=w2 (i1, i2)*w2 (i2, i2)

enddo

enddo

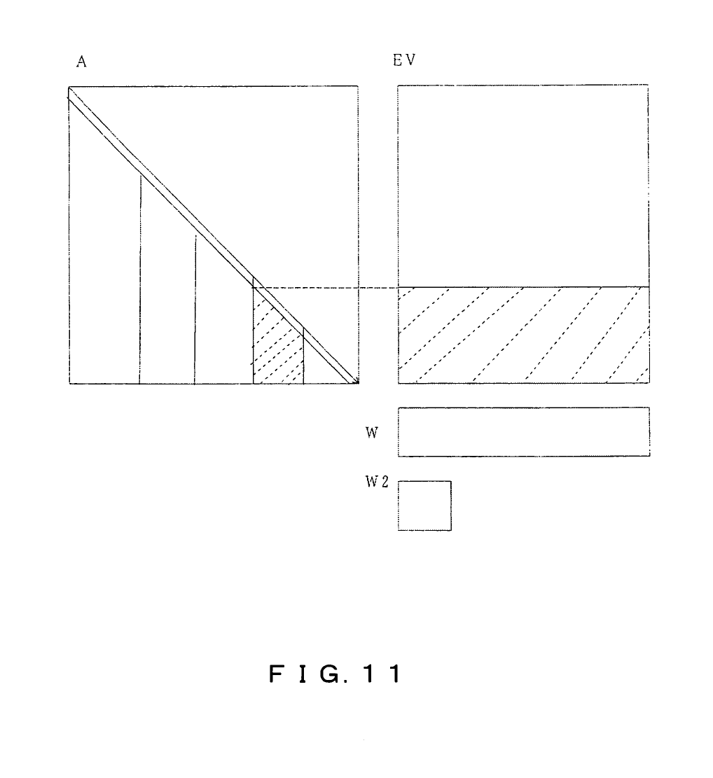

FIG. 11 shows a typical process of converting the eigenvector calculated above into the eigenvector of the original matrix.

The eigenvector is converted by a Householder vector stored in array A. The converted vector is divided into blocks. The shaded portion shown in FIG. 11 is multiplied by the shaded portion of EV, and the result is stored in W. W2 is also created based on block matrix A. W2 and W are multiplied. Then, the block portion of A is multiplied by the product of W2 and W. Then, the shaded portion of EV is updated using the product of the block portion of A and the product of W2 and W.

3. Eigenvalue/Eigenvector of Hermitian Matrix

An algorithm for calculating the eigenvalue/eigenvector of a Hermitian matrix replaces the transposition in the tri-diagonalization of a real symmetric matrix with transposition plus complex conjugation (t→H). A Householder vector is created by changing the magnitude of the vector in order to convert the vector into the scalar multiple of the original element.

The calculated tri-diagonal matrix is a Hermitian matrix, and this matrix is scaled by a diagonal matrix with the absolute value of 1.

A diagonal matrix is created as follows.

dᵢ=1.0, dᵢ₊₁=hᵢ₊₁/|hᵢ₊₁|*dᵢ

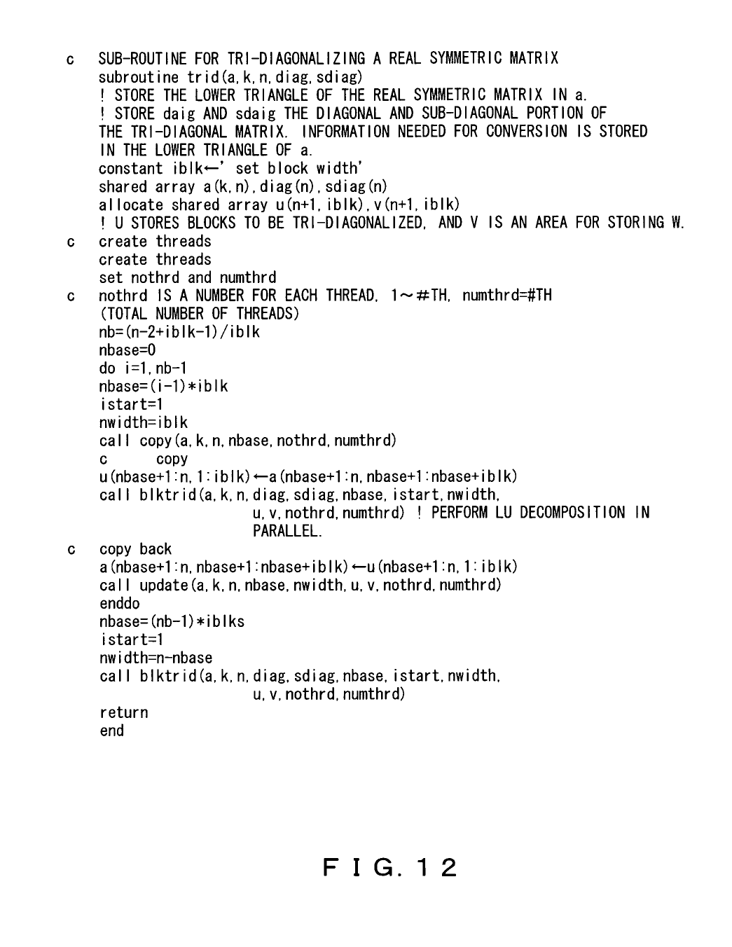

FIGS. 12 through 18 show the respective pseudo-code of routines according to the preferred embodiment of the present invention.

FIG. 12 shows a subroutine for tri-diagonalizing a real symmetric matrix.

Array a is stored in the lower triangle of a real symmetric matrix. The tri-diagonal matrix and sub-diagonal portion are stored in daig and sdiag, respectively. Information needed for conversion is stored in the lower triangle of a as output.

U stores blocks to be tri-diagonalized. V is an area for storing W.

nb is the number of blocks, and nbase indicates the start position of a block.

After subroutine “copy” is executed, a block to be tri-diagonalized in u(nbase+1:n, 1:iblk), routine blktrid is called and LU analysis is performed. Then, the processed u (nbase+1:n, 1:iblk) is written back into the original matrix a. In subsequent processes, the last remaining block is tri-diagonalized using subroutine blktrid.

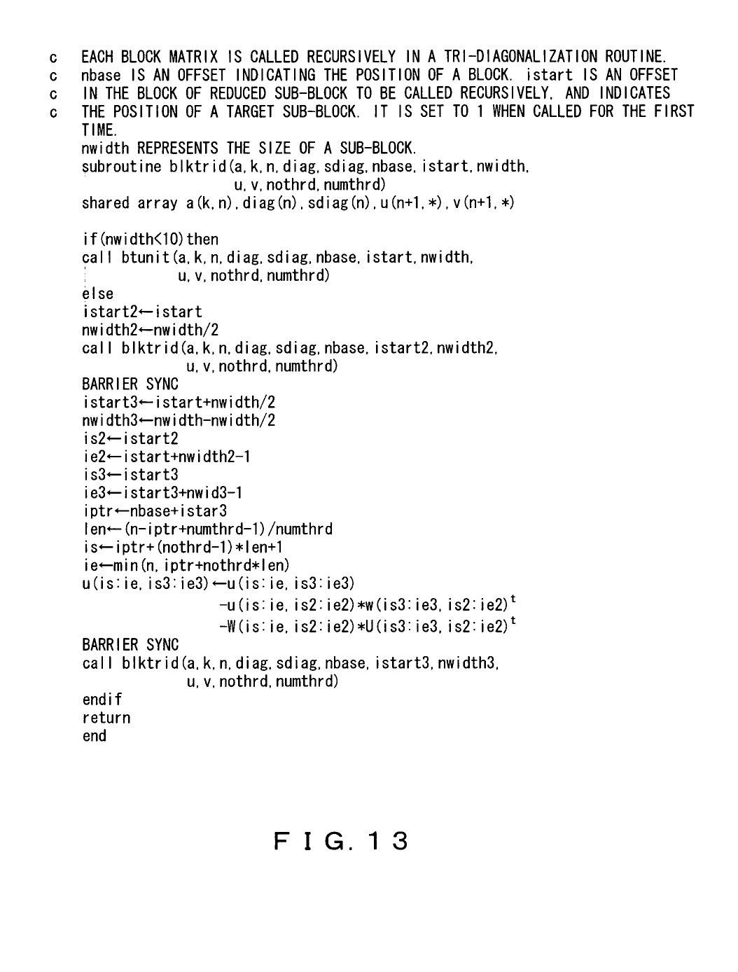

FIG. 13 shows the pseudo-code of a tri-diagonalization subroutine.

This subroutine is a routine for tri-diagonalizing block matrices and is recursively called. nbase is an offset indicating the position of a block. istart is the intra-block offset of a reduced sub-block to be recursively used, and indicates the position of the target sub-block. It is set to “1” when called for the first time. nwidth represents the width of a sub-block.

If nwidth is less than 10, subroutine btunit is called. Otherwise, istart is stored in istart2, a half of nwidth is stored in nwidth2. The sub-block is tri-diagonalized by subroutine blktrid, and then Barrier synchronization is applied.

Furthermore, the sum of istart and nwidth/2 is stored in istart3, and nwidth-nwidth/2 is stored in nwidth 3. Then, a value is set in is2, is3, ie2 and ie3, is and ie, each of which indicates the start or end position of a block, and len and iptr are also set. Then, after calculation is performed according to the expression shown in FIG. 13, the result is stored in u(is:ie, is3:ie3), and Barrier synchronization is applied. Then, tri-diagonalization subroutine blktrid is called and the sub-block is processed. Then, the subroutine process terminates.

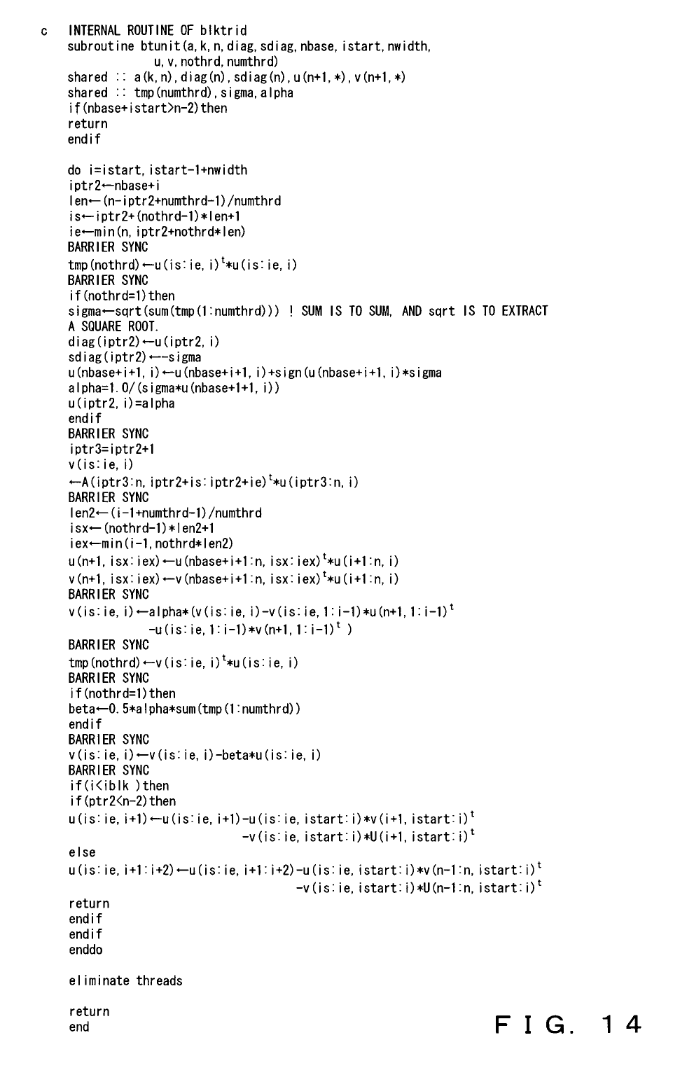

FIG. 14 shows the pseudo-code of the internal routine of a tri-diagonalization subroutine.

In the internal tri-diagonalization subroutine btunit, after necessary information is stored, block start iptr2, width len, start position “is” and end position ie are determined, and Barrier synchronization is applied. Then, u(is:ie,i)t*u(is:ie,i) is stored in tmp, and Barrier synchronization is applied. Then, each value is calculated and is stored in a respective corresponding array. In this routine, sum and sqrt mean to sum and to calculate a square root. Lastly, Barrier synchronization is applied.

Then, v(is:ie,i) is calculated, and Barrier synchronization is applied. Then, lens2, isx, iex, u and v are updated, and Barrier synchronization is applied. Furthermore, v(is:ie,i) is updated, and Barrier synchronization is applied. Furthermore, v(is:ie,i)^{t}*u(is:ie,i) is calculated, tmp is stored and Barrier synchronization is applied.

Then, a value is set in beta, and Barrier synchronization is applied. Then, v is updated by calculation using beta, and Barrier synchronization is applied.

Then, if i<iblk and ptr2<n−2, u(is:ie,i+1) is updated. Otherwise, u(I:ie,i;1:i+2) is updated using another expression and the process terminates. After the execution of this subroutine, the allocated threads are released.

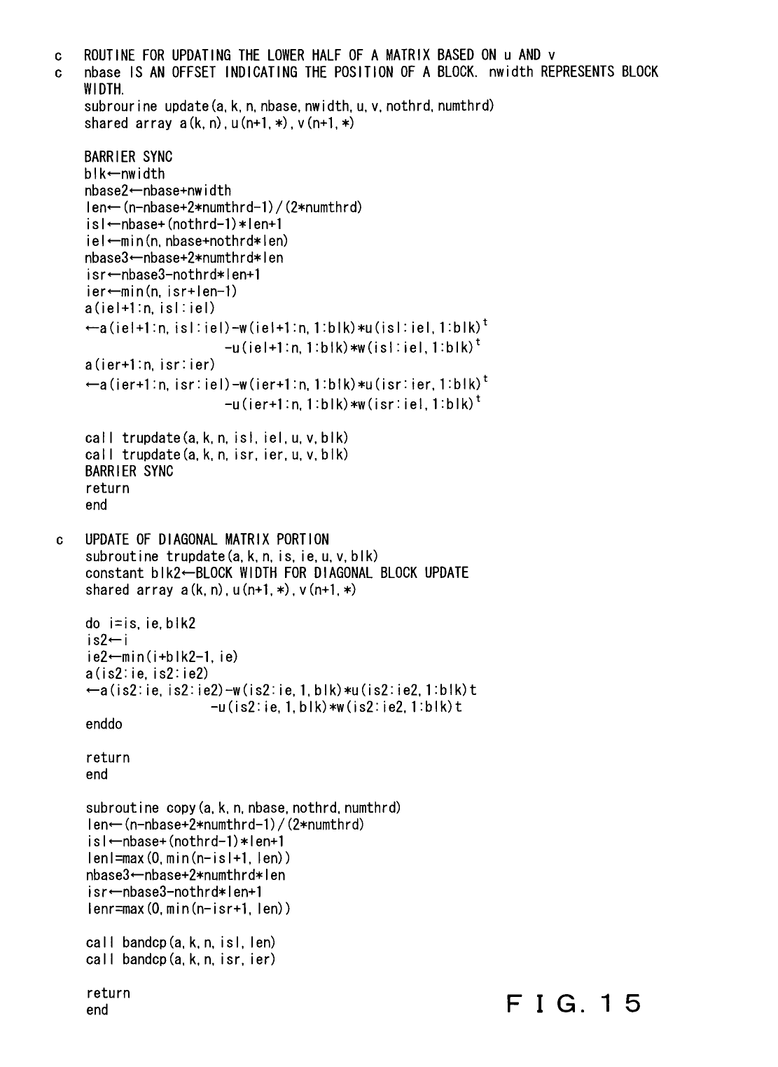

FIG. 15 shows the respective pseudo-code of a routine for updating the lower half of a matrix based on u and v, a routine for updating a diagonal matrix portion and a copy routine.

In this code, nbase and nwidth are an offset indicating the position of a block and block width, respectively.

In this subroutine update, after arrays a, u and v are allocated, Barrier synchronization is applied. Then, after blk, nbase2, len, is1, ie1, nbase3, isr and ier are set, each of a(ie1:n, is1:ie1) and a(ier+1:n, isr:ier) is updated. Then, a subroutine trupdate is called twice, Barrier synchronization is applied and the process is restored to the original routine.

In subroutine copy, len, is1, len1, nbase, isr and lenr are set, bandcp is executed twice and the process is restored to the original routine.

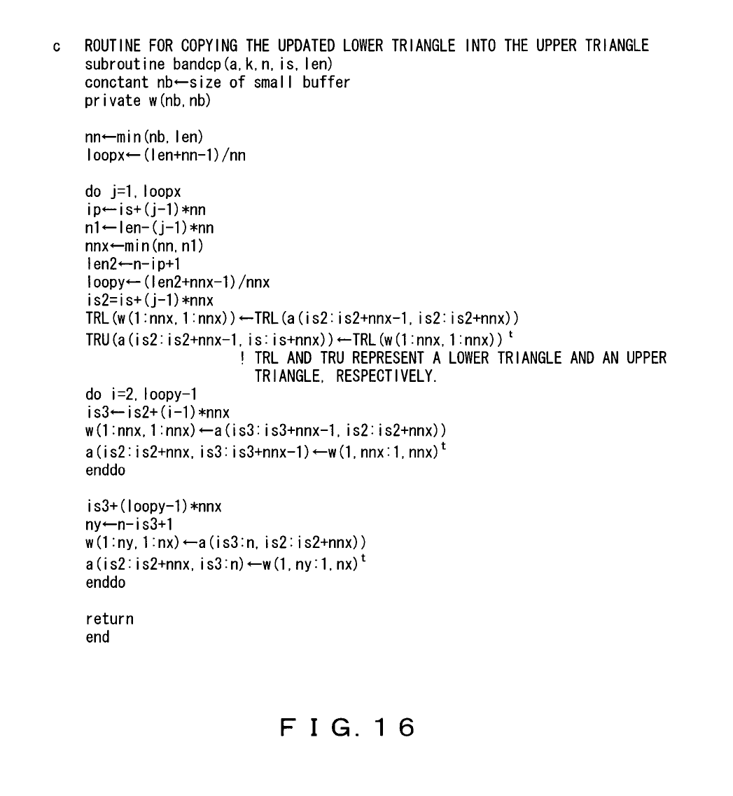

FIG. 16 shows the pseudo-code of a routine copying an updated lower triangle in an upper triangle.

In subroutine bandcp, nb, w, nn and loopx are set. Then, in a loop do, TRL(a(is2:is2+nnx−1, is2:is2+nnx)) and TRL(w(I:nnx,1:nnx))^{t} are stored in TRL(w(1:nnx,1:nnx)) and TRU(a(is2:is2+nnx−1, is:is+nnx)), respectively. In this case, TRL and TRU represent a lower triangle and an upper triangle, respectively.

Then, w(1:nnx,1:nnx) and a(is2:is2+nnx, is3:is3+nnx−1) are updated. Then, w(1:ny,1:nx) and a(is2:is2+nnx, is3:n) are updated.

Then, after the do loop has finished, the process is restored to the original routine.

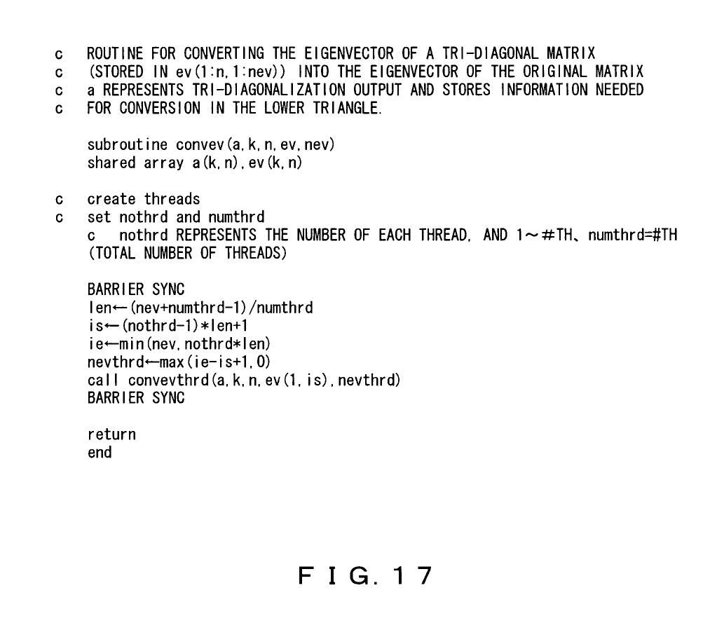

FIG. 17 shows the pseudo-code of a routine for converting the eigenvector of a tri-diagonal matrix into the eigenvector of the original matrix.

In this case, the eigenvector of a tri-diagonal matrix is stored in ev(1:n,1:nev). a is the output of tri-diagonalization and stores information needed for conversion in a lower diagonal portion.

Subroutine convev takes array arguments a and ev.

Subroutine convev creates threads and performs a parallel process.

Barrier synchronization is applied and len, is, ie and nevthrd are set. Then, routine convevthrd is called, and Barrier synchronized is applied after restoration and the process terminates.

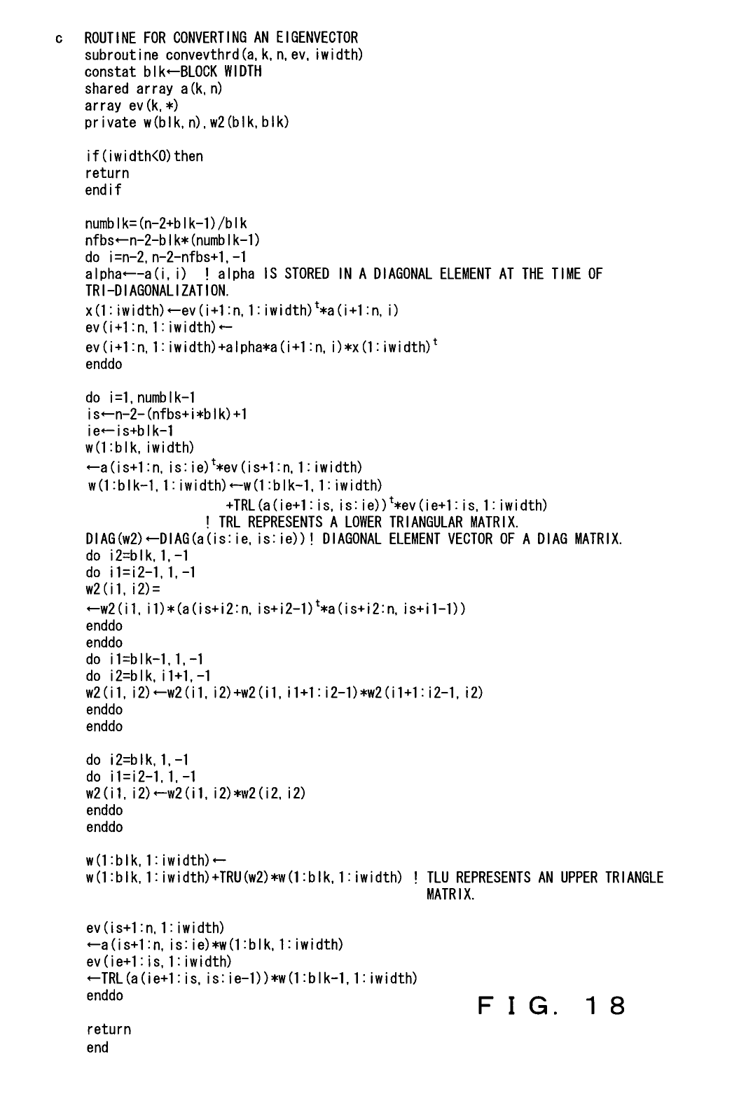

FIG. 18 shows the pseudo-code of a routine for converting eigenvectors.

In subroutine convevthrd, block width is stored in blk, and a, ev, w and w2 are taken as arrays.

First, if width is less than 0, the original routine is restored without performing any process. In this case, numblk and nfbs are set, and a value stored in a diagonal element at the time of tri-diagonalization with a code the reverse of the above (−a(i,i))is input in alpha. ev(i+1:n,1:iwidth)^{t}*a(i+1:n,i) is input in x(1:iwidth), and ev is updated using ev(i+1:n,1:iwidth)^{t}*a(i+1:n,i), alpha and a. Furthermore, in a subsequent do sentence, is and ie are set, a(is+1:n,is:ie)^{t}*ev(is+1:n,1:iwidth) is replaced with a(is+1:n,is:ie)^{t}*ev(is+1:n,1:iwidth) and w(1:blk,1:iwidth) is updated by TRL(a(ie+1:is, is:ie))^{t}*ev(ie+1:is,1:iwidth). In this case, TRL is a lower triangular matrix.

The diagonal element vector of a (is:ie, is:ie) is stored in the diagonal element vector DIAG(w2) of w2.

In a subsequent do sentence, w2 (i1,i2) is updated by w2(i1,i2)*(a(is+12:n,is+i2−1)^{t}*a(is+i2:n,is;i1−1)). Furthermore, in a subsequent do sentence, w2(i1,i2) is updated by w2(i1,i2)+w2(i1,i1+1:i2−1)*w2(i1+1:i2−1,i2).

Furthermore, in a subsequent do sentence, w2(i1,i2) is updated by w2(i1,i2)*w2(i2,i2). Then, w(1:blk,1:iwidth), ev(is+n:n,1:iwidth) and ev(ie+1:is,1:iwidth) are updated and the flow is restored to the original routine.

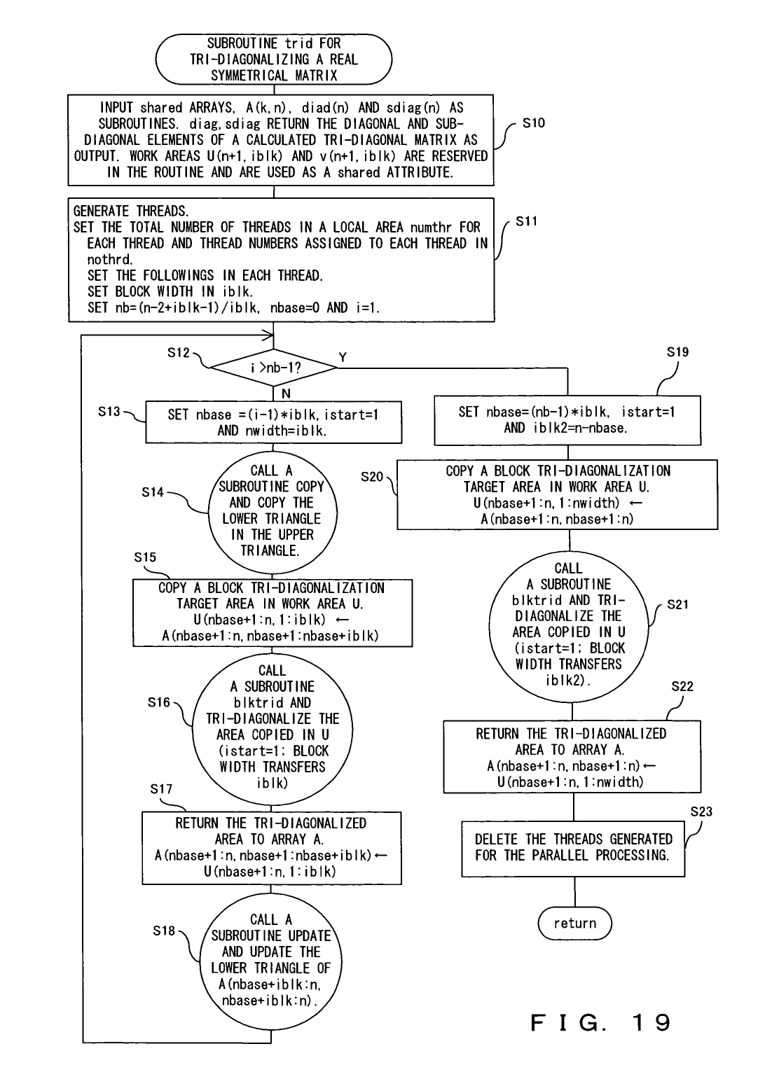

FIGS. 19 through 29 are flowcharts showing a pseudo-code process.

FIG. 19 is a flowchart showing a subroutine trid for tri-diagonalizing a real symmetric matrix. In step S10, shared arrays, A(k,n), diag(n) and sdiag(n) are inputted as subroutines. diag and sdiag return the diagonal and sub-diagonal elements of a calculated tri-diagonal matrix as output. Work areas U(n+1,iblk) and v(n+1,iblk) are reserved in the routine and are used in a shared attribute. Instep S11, threads are generated. In each thread, the total number of threads and a thread number assigned to each thread are set in local areas numthr and nothrd, respectively. Then, in each thread, the following items are set. Block width is set in iblk, and nb=(n−2+iblk−1)/iblk, nbase=0 and i=1 are set. In step S12, it is judged whether i>nb−1. If the judgment in step S12 is positive, the flow proceeds to step S19. If the judgment in step S12 is negative, in step S13, nbase=(i−1)×iblk, istart=1 and nwidth=iblk are set. In step S14, a subroutine copy is called and the lower triangle is copied in the upper triangle. In step S15, a target area to which block tri-diagonalization is applied is copied in a work area U. Specifically, U(nbase+1:n,1:iblk)←A(nbase+1:n,nbase+1:nbase+iblk) is executed. In step S16, a subroutine blktrid is called and the area copied in U is tri-diagonalized (istart=1; the block width transfers iblk) . In step S17, the tri-diagonalized area is returned to an array A. Specifically, A(nbase+1:n,nbase+1:nbase+iblk)←U(nbase+1:n,1:iblk) is executed. In step S18, a subroutine update is called, and the lower triangle of A(nbase+1iblk:n,nbase+iblk:n) is updated, and the flow returns to step S12.

In step S19, nbase=(nb−1)×iblk, istart=1 and iblk2=n−nbase are set. In step S20, the block-tri-diagonalization target area is copied in a work area U. Specifically, U(nbase+1:n,1:nwidth)←A(nbase+1:n,nbase+1:n) is executed. In step S21, a subroutine blktrid is called, and the copied area is tri-diagonalized (istart=1; the block width transfers iblk2). In step S22, the tri-diaginalized area is returned to array A. Specifically, A(nbase+1:n,nbase+1:n)←U(nbase+1:n,1:nwidth) is executed. In step S23, the threads generated for the parallel processing are deleted, and the subroutine terminates.

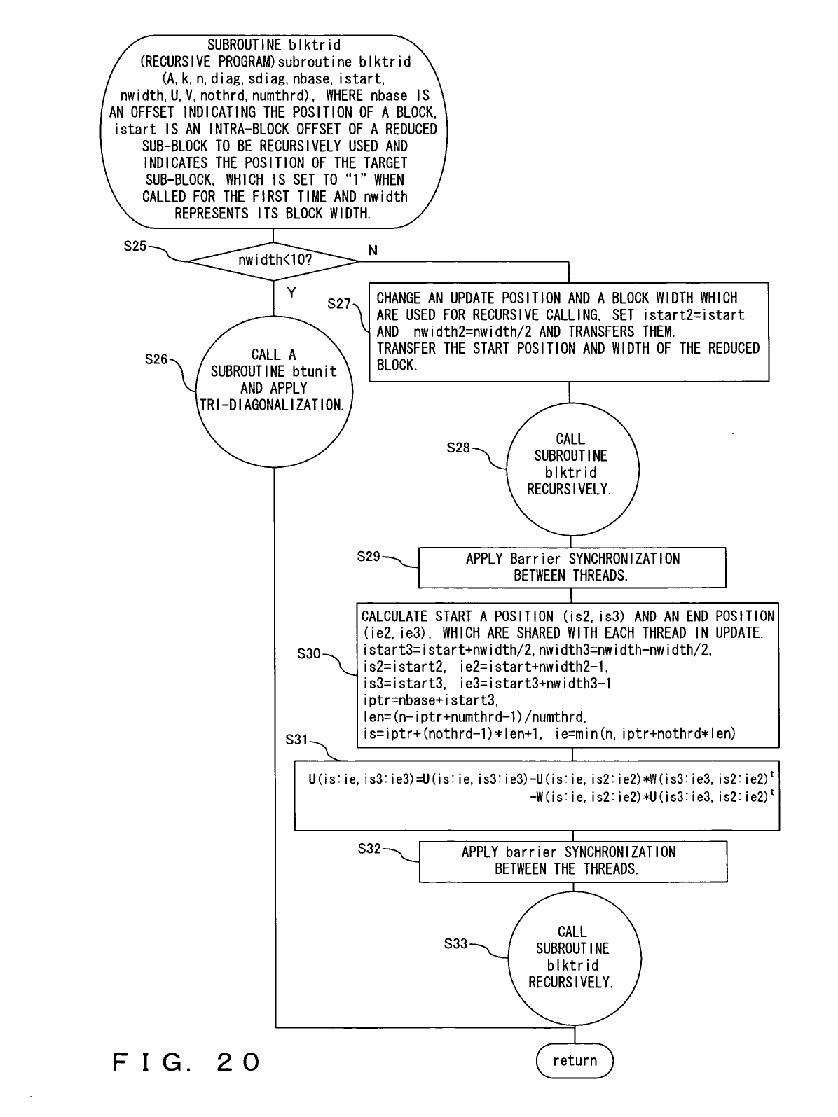

FIG. 20 is a flowchart showing a subroutine blktrid. This subroutine is a recursive program.

This subroutine is called by the following statement.

Subroutine blktrid (A,k,n,dig,sdig,nbase,istart,nwidth,U,V,nothrd, numthrd), where nbase is an offset indicating the position of a block, istart is an intra-block offset of a reduced sub-block to be recursively used and indicates the position of the target sub-block, which is set to “1” when called for the first time, and nwidth represents its block width. In step S25, it is judged whether nwidth<10. If the judgment in step S25 is negative, the flow proceeds to step S27. If the judgment in step S25 is positive, in step S26, a subroutine btunit is called, and tri-diagonalization is applied. Then, the subroutine terminates. In step S27, an update position and a block width which are used for recursive calling are changed, istart2=2istart and nwidth=nwidth/2 are set, and are transferred. The start position and width of the reduced block are transferred. In step S28, a subroutine blktrid is recursively called. In step S29, barrier synchronization is applied between the threads. In step S30, a start position (is2,is3) and an end position (ie2,ie3), which are shared with each thread in update, are calculated. Specifically, istart3=istart+nwidth/2, nwidth3=nwidth−nwidth/2, is2=istart2, ie2=istart+nwidth2−1, is3=istart3, ie3=istart3+nwidth3−1, iptr=nbase+istart3, len=(n−iptr+numthrd−1)/numthrd, is=iptr+(nothrd−1)×len+1 and ie=min(n,iptr+nothrd×len) are calculated. In step S31, U(is:ie,is3:ie3)=U(is:ie,is3:ie3)−U(is:ie,is2:ie2)×W (is3:ie3,is2:ie2)^{t}−W(is:ie,is2:ie2)×U(is3:ie3,is2:ie2)^{t} are calculated. Instep S32, barrier synchronization is applied between the threads. In step S33, a subroutine blktrid is recursively called, and the subroutine terminates.

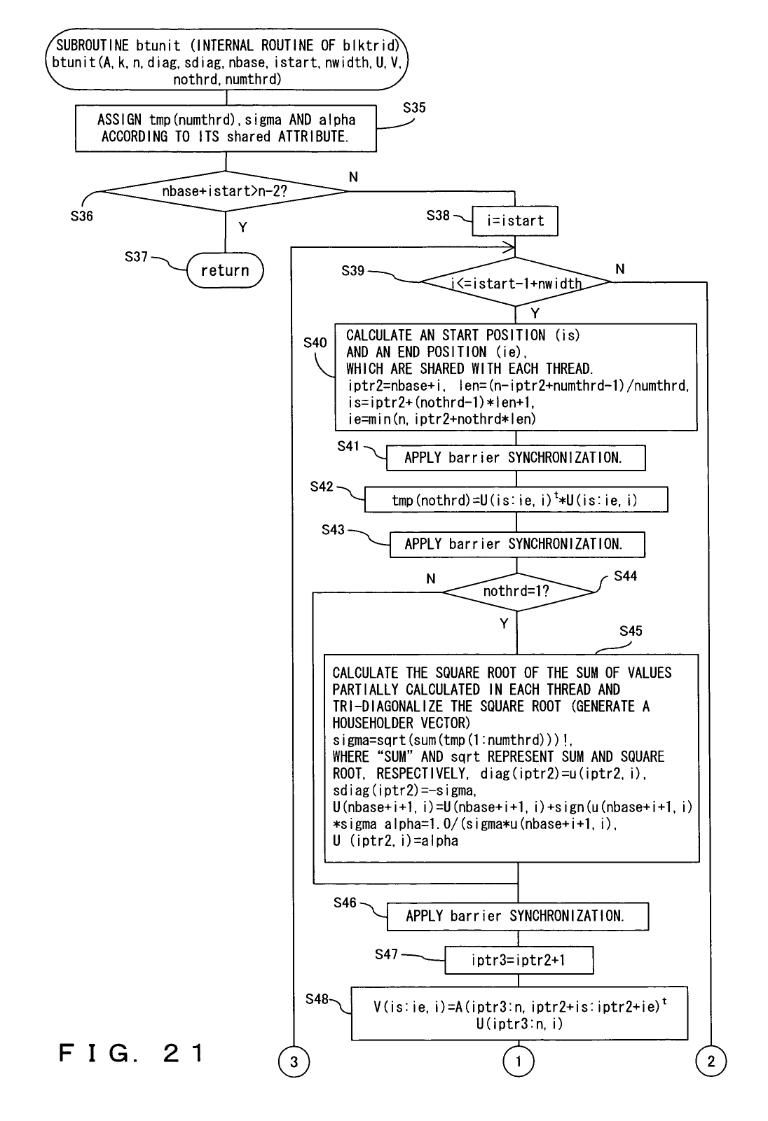

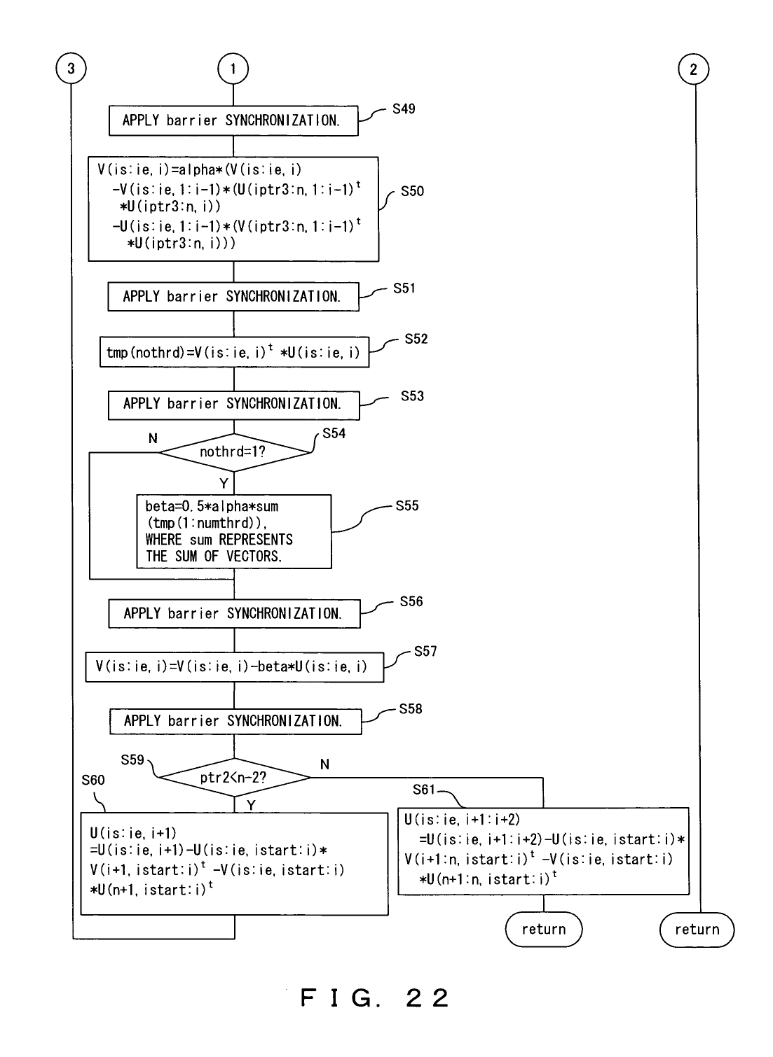

FIGS. 21 and 22 are flowcharts showing a subroutine btunit, which is an internal routine of subroutine blktrid.

In step S35, tmp(numthrd), sigma and alpha are assigned according to its shared attribute. In step S36, it is judged whether nbase+istart>n−2. If the judgment in step S36 is positive, the subroutine terminates. If the judgment in step S36 is negative, the flow proceeds to step S38. In this case, in step S38 i=istart is set. In step S39 it is judged whether i≦istart−1+nwidth. If the judgment in step S39 is negative, the subroutine terminates. If the judgment in step S39 is positive, in step S40, start positions “is” and end positions ie which are shared with each thread are calculated. iptr2=nbase+i, len=(n−iptr2+numthrd−1)/numthrd, is=iptr2+(nothrd−1)×len+1 and ie=min(n,iptr2+nothrd×len) are calculated. In step S41, barrier synchronization is applied. In step S42, tmp(nothrd)=U(is:ie,i)^{t}×U(is:ie,i) is calculated. In step S43, barrier synchronization is applied. In step S44, it is judged whether nothrd=1. If the judgment in step S44 is negative, the flow proceeds to step S46. If the judgment in step S44 is positive, in step S45, the square root of the sum of values partially calculated in each thread is calculated and is tri-diagonalized (generation of a householder vector).

sigma=sqrt(sum(tmp(1:numthrd)))

where “sum” and sqrt represent sum and square root. diag(iptr2)=u(iptr2,i), sdiag(iptr2)=−sigma, U(nbase+i+1,i)=U(nbase+i+1,i)+sign(u(nbase+i+1,i)×sigma, alpha=1.0/(sigma×u(nbase+i+1,i) and U(iptr2,i)=alpha are calculated, and the flow proceeds to step S46. In step S46, barrier synchronization is applied. In step S47, iptr3=iptr2+1 is calculated. In step S48, V(is:ie,i)=A(iptr3:n,iptr2+is:iptr2+ie)^{t}U(ptr3:n,i) is calculated. In step S49, barrier synchronization is applied.

In step S50, V(is:ie,i)=alpha×V(is:ie,i)−V(is:ie,1:i−1)×(U(iptr3:n,l:i−1)^{t}×U(iptr3:n,i))−U(is:ie,1:i−1)×(V(iptr3:n,1:i−1)^{t}×U(iptr3:n,i)) is calculated. In step S51, barrier synchronization is applied. In step S52, tmp(nothrd)=V(is:ie,i)^{t}×U(is:ie,i) is calculated. In step S53, barrier synchronization is applied. In step S54, it is judged whether nothrd=1. If the judgment in step S54 is negative, the flow proceeds to step S56. If the judgment in step S54 is positive, the flow proceeds to step S55. In step S55, beta=0.5×alpha×sum(1:numthrd)) is calculated, where “sum” is a symbol for summing vectors. In step S56, barrier synchronization is applied. In step S57, V(is:ie,i)=V(i:ie,i)−beta×U(is:ie,i) is calculated. In step S58, barrier synchronization is applied. In step S59, it is judged whether ptr2<n−2. If the judgment in step S59 is positive, in step S60, U(is;ie,i+1)=U(is:ie,i+1)−U(is:ie,istart:i)×V(i+1, is tart:1)^{t}−V(is:ie,istart:i)×U(n+1,istart:1)^{t} is calculated, and the flow returns to step S39. If the judgment in step S59 is negative, in step S61, U(is:ie,i+1:i+2)=U(is:ie,i+1:i+2)−U(is:ie,istart:i)×V(i+1:n,istart:i)^{t}−V(is:ie,istart:i)×U(n+1:n,istart:i)^{t} is calculated and the subroutine terminates.

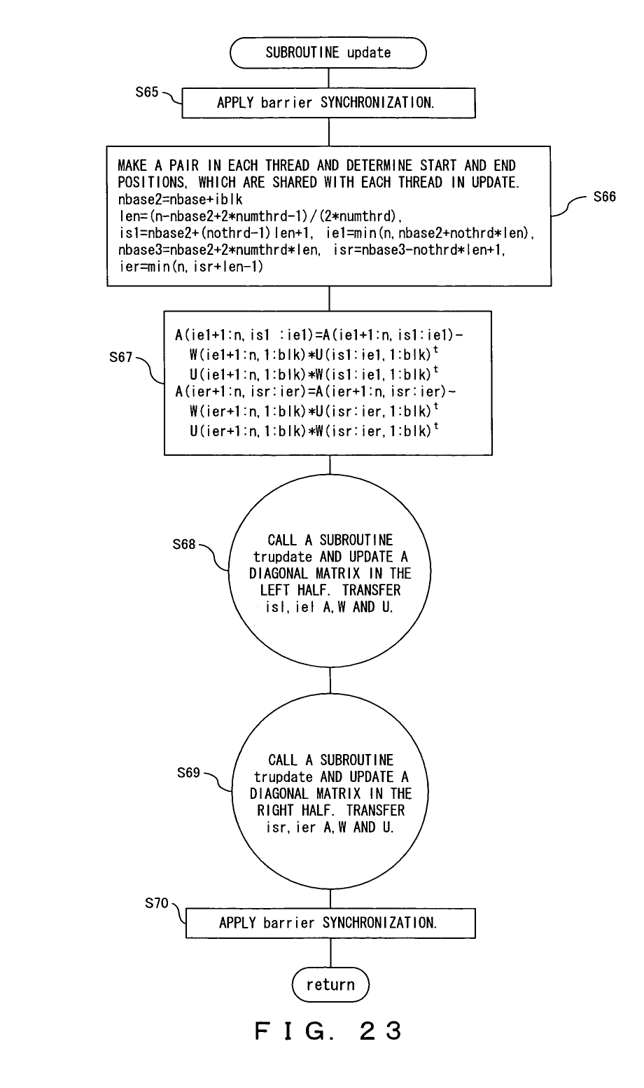

FIG. 23 is a flowchart showing a subroutine update.

In step S65, barrier synchronization is applied. In step S66, a pair is generated in each thread, and start and end positions, which are shared with each thread in update, are determined. Specifically, nbase2=nbase+iblk, len(n−nbase2+2×numthrd−1)/(2×numthrd), is1=nbase2+(nothrd−1)×len+1, ie1=min(n,nbase2+nothrd×len), nbase3=nbase2+2×numthrd×len, isr=nbase3−nothrd×len+1 and ier=min(n,isr+len−1) are calculated. In step S67, A(ie1+1:n,is1:ie1)=A(ie1+1:n,is1+1:n,is1:ie1)−W(ie1+1:n,1:blk)×U(is1:ie1,1:blk)^{t}−U(ie1;1:n,1:blk)×W(is1:ie1,1:blk)^{t} and A(ier+1:n,isr:ier)=A(ier+1:n,isr:ier)−W(ier+1:n,1:blk)×U(isr:ier,1:blk)^{t}−U(ier+1:n,1:blk)×W(isr:ier,1:blk)^{t} are calculated. In step S68, a subroutine trupdate is called, and a diagonal matrix in the left half is updated. is1, ie1, A, W and U are transferred. In step S69, subroutine trupdate is called and a diagonal matrix in the right half is updated. isr, ier, A, W and U are transferred. In step S70, barrier synchronization is applied, and the subroutine terminates.

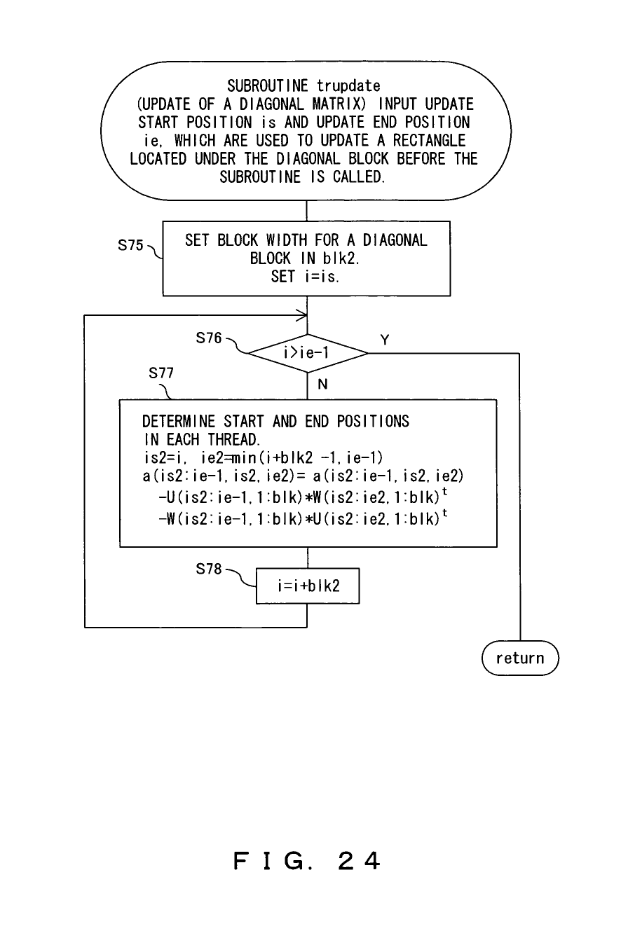

FIG. 24 is a flowchart showing a subroutine trupdate (update of a diagonal matrix). Update start position “is” and update end position ie are inputted, are used to update a rectangle located under the diagonal block before the subroutine is called.

In step S75, block width for diagonal block update is set in blk2, and i=is is set. In step S76, it is judged whether i>ie−1. If the judgment in step S76 is positive, the subroutine terminates. If the judgment in step S76 is negative, in step S77, update start and end positions in each thread are determined. Specifically, is2=i, ie2=min(i+blk2−1,ie−1), A(is2:ie−1,is2,ie2)=A(is2:ie−1,is2,ie2)−U(is2:ie−1, 1:blk)×W(is2:ie2,1:blk)^{t}−W(is2:ie1−1,1:blk)×U(is2:ie2,1:blk)^{t} are calculated. In step 78, i=i+blk2 is set. The flow returns to step S76.

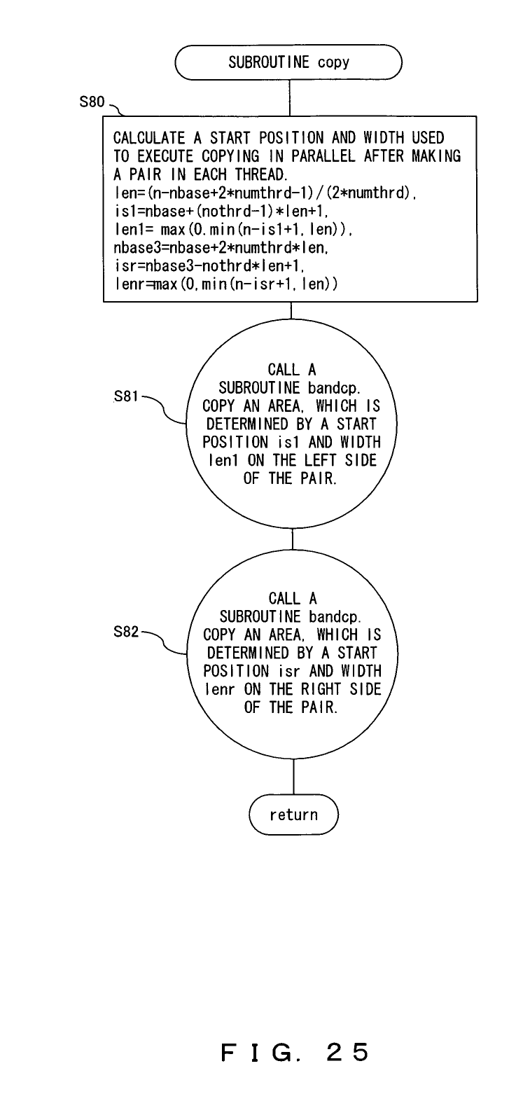

FIG. 25 is a flowchart showing a subroutine copy.

In step S80, a start position and width used to execute copying in parallel after making a pair in each thread, are calculated. Specifically, len=(n−nbase+2×numthrd−1)/(2×numthrd), is1=nbase+(nothrd−1)×len+1, len1=max(0,min(n−is1+1,len9) and nbase3=nbase+2×numthrd×len, isr=nbase3−nothrd×len+1 and lenr=max(0,min(n−isr+1,len)) are calculated. In step S81, a subroutine bandcp is called. An area, which is determined by a start position is1 and width len1 on the left side of the pair, is copied. In step S82, subroutine bandcp is called, and an area, which is determined by a start position isr and width lenr on the right side of the pair, is copied.

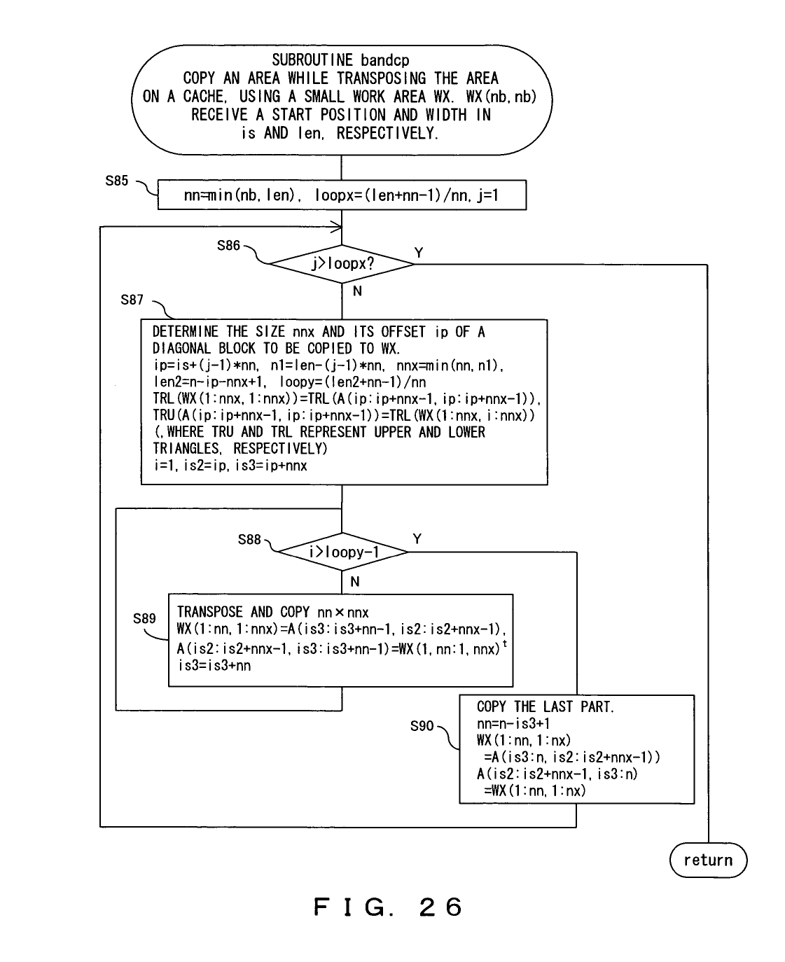

FIG. 26 is a flowchart showing a subroutine bandcp.

This routine copies an area while transposing the matrix on a cache, using a small work area WX. A start position and width are received in “is” and len, respectively, while work area is set as WX(nb,nb).

In step S85, nn=min(nb,len), loopx=(len+nn−1)/nn and j=1 are calculated. Instep S86, it is judged whether j>loopx. If the judgment in step S86 is positive, the subroutine terminates. If the judgment in step S86 is negative, in step S87, the size nnx and its offset ip of a diagonal block to be copied in WX are determined. Ip=is+(j−1)×nn, n1=len−(j−1)×nn, nnx=min (nn,nl), len2=n−ip−nnx+1, loopy=(len2+nn−1)/nn, TRL(WX(1:nnx,1nnx))=TRL(A(ip:ip+nnx−1,ip:ip+nnx−1)), TRU(A(ip:ip+nnx−1,ip:ip+nnx−1))=TRL(WX(1:nnx,i:nnx)), i=1, is2=ip and is3=ip+nnx are calculated, where TRU and TRL represent an upper triangle and a lower triangle, respectively.

In step S88, it is judged whether i>loopy−1. If the judgment in step S88 is negative, in step S89, an area nn×nnx is transposed and copied. Specifically, WX(1:nn,1nnx)=A(is3:is3+nn−1,is2:is2+nnx−1), A(is2:is2+nnx−1,is3:is3+nn−1)=WX(1,nn:1,nnx)^{t} and is3=is3+nn are calculated, and the flow returns to step S88. If the judgment in step S88 is positive, in step S90, the last part is copied. Specifically, nn=n−is3+1, WX(1:nn,1:nx)=A(is3:n,is2:is2+nnx−1) and A(is2:is2+nnx−1,is3:n)=WX(1:nn,1:nx) are calculated and the flow returns to step S86.

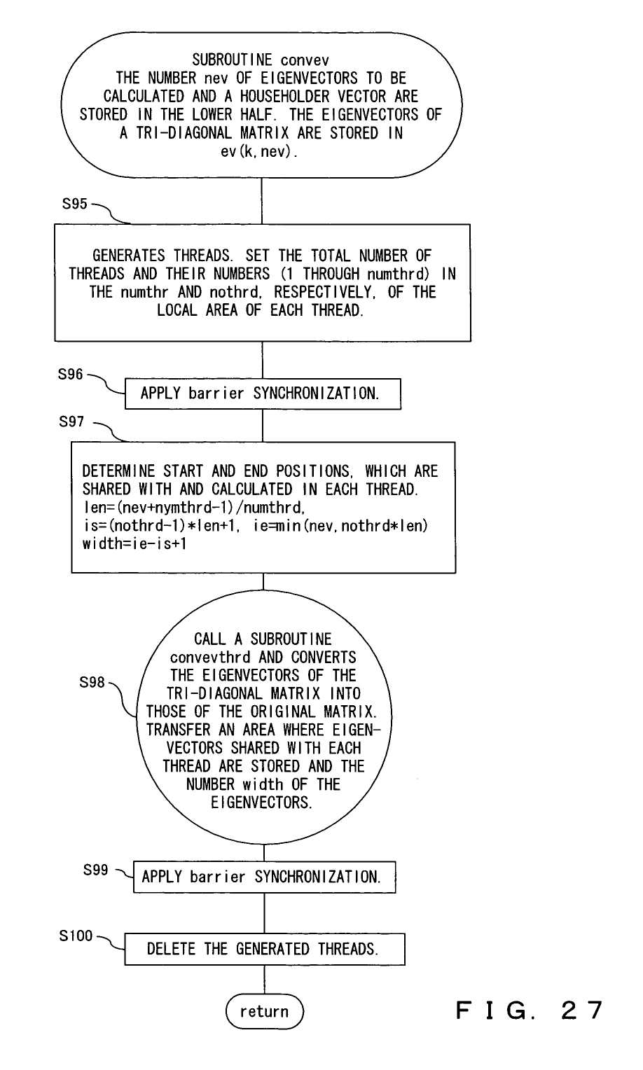

FIG. 27 is a flowchart showing a subroutine convev.

In this routine, the number nev of eigenvectors to be calculated and a householder vector are stored in the lower half of “a”. The eigenvectors of a tri-diagonal matrix are stored in ev (k,nev).

In step S95, threads are generated. The total number of threads and their numbers (1 through numthrd) are set in numthr and nothrd, respectively, of the local area of each thread. In step S96, barrier synchronization is applied. In step S79, start and end positions, which are shared with and calculated in each thread, are determined. Specifically, len=(nev+numthrd−1)/numthrd, is=(nothrd−1)×len+1, ie=min(nev,nothrd×len) and width=ie−is+1 are calculated. In step S98, a subroutine convevthrd is called, and the eigenvector of the tri-diagonal matrix is converted into that of the original matrix. An area where eigenvectors shared with each thread are stored and the number of eigenvectors “width” are transferred. In step S99, barrier synchronization is applied. In step S100, the generated threads are deleted, and the subroutine terminates,

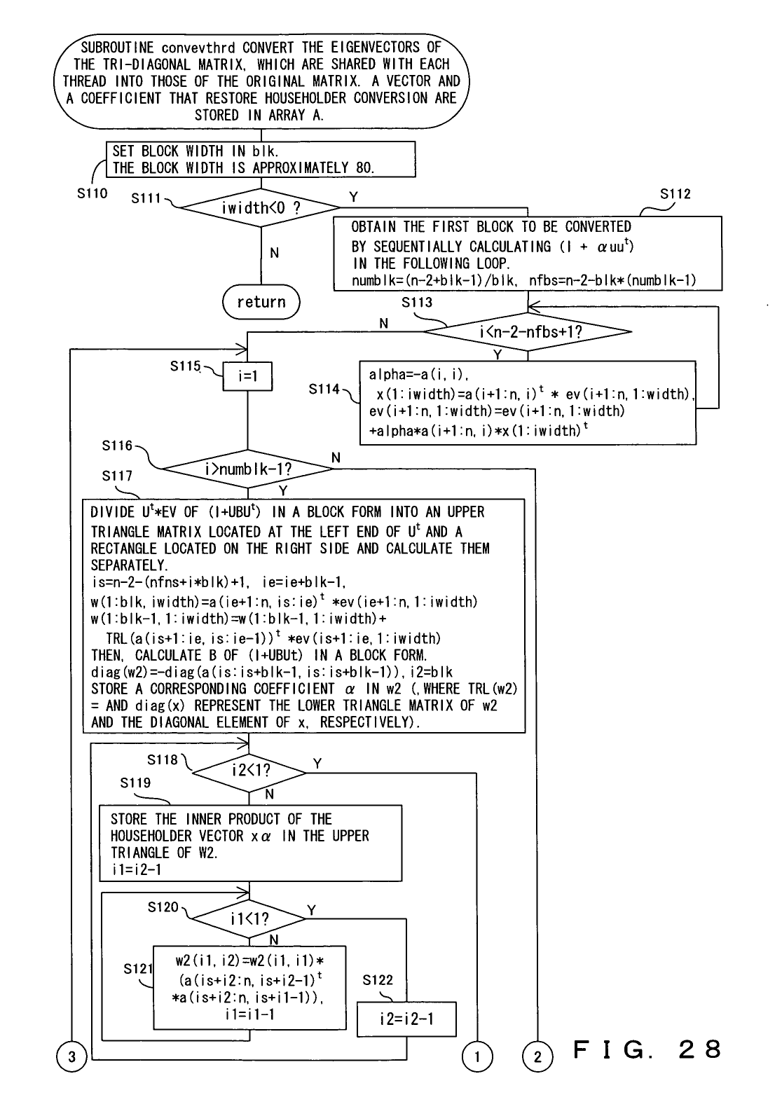

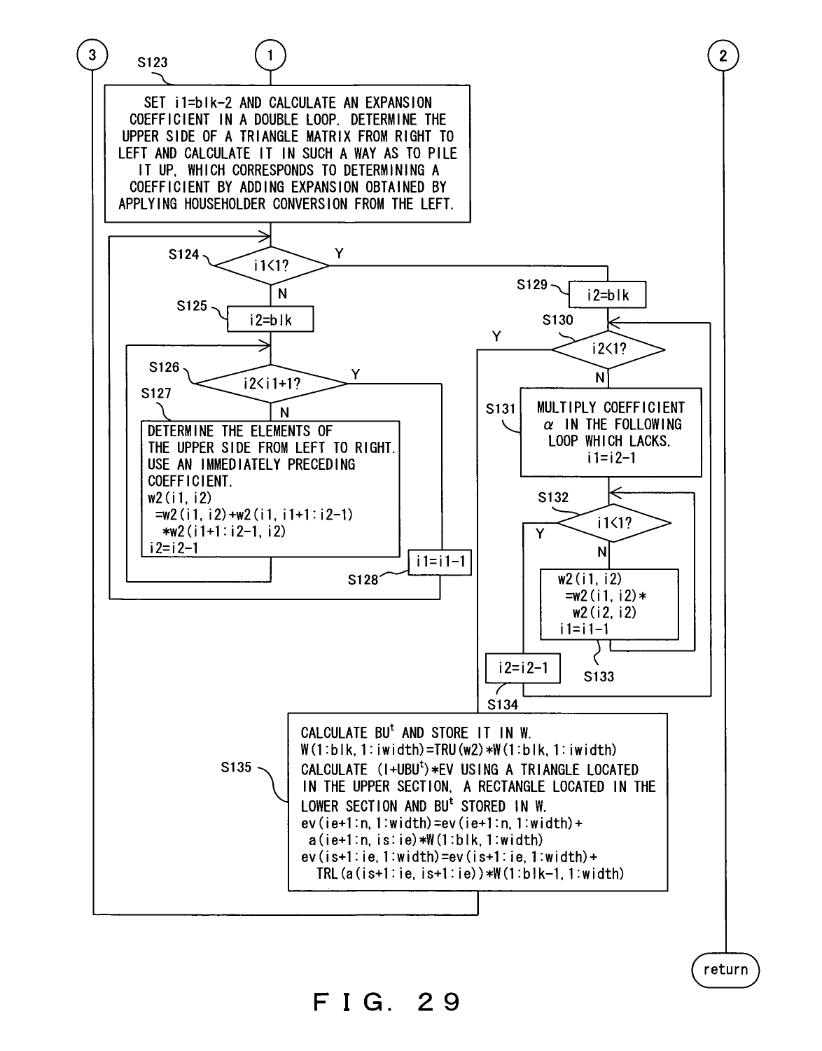

FIGS. 28 and 29 are flowcharts showing a subroutine convevthrd.

This routine converts the eigenvectors of a tri-diagonal matrix, which are shared with each thread, into those of the original matrix. A vector and a coefficient that restore householder conversion are stored in array A.

Instep S110, a block width is set in blk. The block width is approximately 80. In step S111, it is judged whether iwidth<0. If the judgement in the step S111 is positive, the subroutine terminates. If the judgment in the step S111 is negative, the flow proceeds to step s112. In step s112, the first block to be converted in the following loop is obtained by sequentially calculating (1+αuu^{t}). Firstly, numblk=(n−2+blk−1)/blk and nfbs=n−2−blk×(numblk−1) are calculated. In step S113, it is judged whether i<n−2−nfbs+1. If the judgment instep S113 is positive, the flow proceeds to step S114. In step S114, alpha=−a(i,i), x(1:iwidth)=a(i+1:n,i)^{t}×ev(i+1:n,1:width) and ev(i+1:n,1:width)=ev(i+1:n,1:width)+alpha×a(i+1:n,i)×(1:iwidth)^{t} are calculated, and the flow returns to step s113. If the judgment in step S113 is negative, in step S115, i=1 is set. In step S116, it is judged whether i>numblk−1. I the judgment in step S116 is negative, the subroutine terminates. If the judgment in step S116 is positive, in step S117, U^{t}×EV of (1+UBU^{t}) in a block form is divided into an upper triangle matrix at the left end of U^{t} and a rectangle on the right side, and they are separately calculated. Specifically, is=n−2−(nfns+1×blk)+1 and ie=ie+blk−1, W(1:blk,iwidth)=a(ie+1:n,is:ie)^{t}×ev(is+1:ie,1:iwidth), W(1:blk−1, 1:iwidth)=w(1:blk−1, 1:iwidth)+TRL(a(is+1:ie, is:ie−1))^{t}×ev(is+1:ie, 1:iwidth) are calculated. Then, B of (1+UBU^{t}) in a block form is calculated. diag(w2)=−diag(a(is:is+blk−1,is:blk−1)) and i2=blk are calculated. A coefficient α corresponding to w2 is stored. In the above description, TRL (w2) and diag (x) represent the lower triangle matrix of w2 and the diagonal element of x, respectively.

In step S118, it is judged whether i2<1. If the judgment in step S118 is negative, in step S119, the inner product of a householder vector ×α is stored in the upper triangle of w2, and i1=i2−1 is set. In step s120, it is judged whether i1<1. If the judgment in step S120 is negative, in step S121, w2(i1,i2)=w2(i1,i1)×(a(is+i2:n,is+i2−1)^{t}×a(is+i2:n, is+i1−1)) and i1=i1−1 are calculated, and the flow returns to step S120. If the judgment in step S120 is positive, in step S122, i2=i2−1 is set, and the flow returns to step S118. If the judgment in step S118 is positive in step S123, i1=blk−2 is set, and then, an expansion coefficient is calculated in a double loop. The upper side of a triangle matrix is determined from right to left, and is calculated in such a way as to pile it up. This corresponds to determining a coefficient by adding expansion obtained by applying householder conversion from the left. In step s124, it is judged whether i1<1. If the judgment in step S124 is negative, in step S125, i2=blk is set. In step S126, it is judged whether i2<i1+1. If the judgment in step S126 is negative, in step S127, the elements of the upper side are determined from left to right. In this case, an immediately preceding coefficient is used. Specifically, w2(i,i2)=w2(i1,i2)+w2(i1,i1+1:i2−1)×w2(i1+1:i2−1,i2) and i2=i2−1 are calculated, and the flow returns to step S126. If the judgment in step S126 is positive, in step S128, i1−i1−1 is set, and the flow returns to step S124. If the judgment in step S124 is positive, the flow proceeds to step S129, and i2=blk is set. In step s130, it is judged whether i2<1. If the judgment in step S130 is negative, in step S131, coefficient α, which lacks, is multiplied in the following loop. Firstly, i1=i2−1 is set. In step S132, it is judged whether i1<1. If the judgment in step S132 is negative, in step S133, w2(i1.i2)=w2(i2,i2)×w2(i2,i2) and i1=i1−1 are calculated, and the flow returns to step S132. If the judgment in step S132 is positive, in step S134, i2=i2−1 is set, and the flow returns to step S130. If the judgment in step S130 is positive, in step S135, BU^{t} is calculated and is stored in W. W(1:blk,1:iwidth)=TRU(w2)×W(1:blk,1:iwidth) is calculated. Then, (1+UBU^{t})×EV is calculated using a triangle located in the upper section of U, a rectangle located in the lower section of U and BU^{t} stored in W. Specifically, ev(ie+1:n,1:width)=ev(ie+1:n,1:width)+a(ie+1:n,is:ie)×W(1:blk,1:width), ev(is+1:ie,1:width)=ev(is+1:ie, 1:width)+TRL(a(is+1:ie, is+1:ie)) ×W(1:blk−1, 1:width) is calculated, and the flow returns to step S115.

According to the present invention, a high-performance and scalable eigenvalue/eigenvector parallel calculation method can be provided using a shared-memory type scalar parallel computer.

According to the preferred embodiment of the present invention, in particular, the speed of eigenvector conversion calculation can be improved to be about ten times as fast as the conventional method. The eigenvalue/eigenvector of a real symmetric matrix calculated using these algorithms can also be calculated using Sturm's method and an inverse repetition method. The speed of calculation using seven CPUs is 6.7 times faster than the function of the numeric value calculation library of SUN called SUN performance library. The speed of the method of the present invention is also 2.3 times faster than a method for calculating the eigenvalue/eigenvector of a tri-diagonal matrix by a “divide & conquer” method, of another routine from SUN (in this case, it is inferior in function: eigenvalue/eigenvector cannot be selectively calculated).

The eigenvalue/eigenvector of a Hermitian matrix obtained using these algorithms can also be calculated using Sturm's method and an inverse repetition method. The speed of the method of the present invention using seven CPUs is 4.8 times faster than the function of the numeric value calculation library of SUN called the SUN performance library. The speed of the method of the present invention is also 3.8 times faster than a method for calculating the eigenvalue/eigenvector of a tri-diagonal matrix by a “divide & conquer” method, of another routine of SUN (in this case, it is inferior in function: eigenvalue cannot be selectively calculated).

For basic algorithms of matrix computations, see the following textbook:

G. H. Golub and C. F. Van Loan, “Matrix Computations” the third edition, The Johns Hopkins University Press (1996).

For the parallel calculation of tri-diagonalization, see the following reference:

J. Choi, J. J. Dongarra and D. W. Walker, “The Design of a Parallel Dense Linear Algebra Software Library: Reduction to Hessenberg, Traditional, and Bi-diagonal Form”, Engineering Physics and Mathematics Division, Mathematical Sciences Section, prepared by the Oak Ridge National Laboratory managed by Martin Marietta Energy System, Inc., for the U.S. Department of Energy under Contract No. DE-AC05-840R21400, ORNL/TM-12472.

In this way, a high-performance and scalable eigenvalue/eigenvector calculation method can be realized.

What is claimed is:

1. A program enabling a shared-memory type scalar parallel computer to realize a parallel processing method of an eigenvalue problem for a shared-memory type scalar parallel computer, comprising:
dividing a real symmetric matrix or a Hermitian matrix to be processed into blocks, copying each divided block into a work area of a memory and tri-diagonalizing the blocks using products between the blocks;
calculating an eigenvalue and an eigenvector based on the tri-diagonalized matrix; and
converting the eigenvector calculated based on the tri-diagonalized matrix by Householder conversion in order to transform the calculation into parallel calculation of matrices with a prescribed block width and calculating an eigenvector of an original matrix.

2. The program according to claim 1, wherein in said tri-diagonalization step, each divided block is updated by a recursive program.

3. The program according to claim 1, wherein in said tri-diagonalization step, each divided block is further divided into smaller blocks so that data may not be read across a plurality of pages of a cache memory and each processor can calculate such divided blocks in parallel.

4. The program according to claim 1, wherein in said original matrix eigenvector step, a matrix, to which Householder conversion is applied, can be created by each processor simultaneously creating an upper triangular matrix, which is a small co-efficient matrix that can be processed by each processor.

5. The program according to claim 1, wherein in said original matrix eigenvector calculation step, the said eigenvector of the original matrix can be calculated by evenly dividing the second dimensional direction of a stored bi-dimensional array in accordance with the number of processors and assigning each divided area to a processor.

6. A parallel processing method of an eigenvalue problem for a shared-memory type scalar parallel computer, comprising:
dividing a real symmetric matrix or a Hermitian matrix to be calculated into blocks, copying each divided block into a work area of memory and tri-diagonalizing the blocks using products between the blocks;
calculating an eigenvalue and an eigenvector based on the tri-diagonalized matrix; and
converting the eigenvector calculated based on the tri-diagonalized matrix by Householder conversion in order to transform the calculation into parallel calculation of matrices with a prescribed block width and calculating an eigenvector of an original matrix.

7. The parallel processing method according to claim 6, wherein in said tri-diagonalization step, each divided block is updated by a recursive program.

8. The parallel processing method according to claim 6, wherein in said tri-diagonalization step, each divided block is further divided into smaller blocks so that data may not be read across a plurality of pages of a cache memory and each processor can process such divided blocks in parallel.

9. The parallel processing method according to claim 6, wherein in said original matrix eigenvector step, a matrix, to which Householder conversion is applied, can be created by each processor simultaneously creating an upper triangular matrix, which is a small co-efficient matrix that can be processed by each processor.

10. The parallel processing method according to claim 6, wherein in said original matrix eigenvector calculation step, the said eigenvector of the original matrix can be calculated by evenly dividing the second dimensional direction of a stored bi-dimensional array in accordance with the number of processors and assigning each divided area to a processor.
